(19) United States
(12) Patent Application Publication
(10) Pub. No.: US 2004/0054617 A1
(43) Pub. Date: Mar. 18, 2004

(54) Settlement of auctions using complete sets and separate price and quantity determination

(76) Inventor: Kevin KS Fung, Hong Kong (HK)

Correspondence Address: FENWICK & WEST LLP, SILICON VALLEY CENTER, 801 CALIFORNIA STREET, MOUNTAIN VIEW, CA, 94041, US

(21) Appl. No.: 10/600,888

(22) Filed: Jun. 20, 2003

Related U.S. Application Data
(60) Provisional application No. 60/389,956, filed on Jun. 20, 2002.

(51) Int. Cl. G06F 17/60

(52) U.S. Cl. 705/37

(57) ABSTRACT

The orders collected during an auction form an auction pool. An auction settlement price (ASP) for each contract is set. After the ASPs have been set, orders in the auction pool are filled (or not) based on the ASPs, and preferably also the aggressiveness of the order.

### CROSS-REFERENCE TO RELATED APPLICATIONS

This application claims priority under 35 U.S.C. §119(e) to U.S. Provisional Patent Application Serial No. 60/389,956, “Event Risk Management Trading System,” by Kevin K. S. Fung, filed Jun. 20, 2002.

This application also relates to co-pending U.S. patent application Ser. No. ______ (attorney docket no. 2626P), entitled “Method and System for Improving the Liquidity of Transactions,” filed on even date herewith; co-pending U.S. patent application Ser. No. ______ (attorney docket no. 2700P), entitled “Method and System for Utilizing a Special Purpose Vehicle for Improving the Liquidity of Transactions,” filed on even date herewith; and co-pending U.S. patent application Ser. No. ______ (attorney docket no. 2701P), entitled “Method and System for Managing Credit-related and Exchange Rate-related Risk,” filed on even date herewith.

The subject matter of all of the foregoing is incorporated herein by reference in their entirety.

### BACKGROUND OF THE INVENTION

1. Field of the Invention

This invention relates generally to the settlement of auctions and, more particularly, to the settlement of auctions using complete sets.

2. Description of the Related Art

A variety of financial instruments, which shall be referred to generally as contracts, are currently traded in many different markets. These contracts can take a variety of forms and can be related to a variety of activities or events. For example, the contracts could range from options and futures to betting. Participants in the markets typically make offers to buy contract(s) (also known as bids) and/or offers to sell contract(s) (also known as offers). Each offer typically has a price limit associated with it. The participants in the market could include individual participants, financial intermediaries, and/or market makers, such as brokerage houses or banks.

Furthermore, the buyers and sellers can be either short or long. For example, a long seller is a seller already having a position in the market and holding the contract for which the seller makes an offer. A short seller is a seller who does not yet have ownership of the contract being offered for short sale. Similarly, a buyer may be making a bid to cover a contract previously offered for sale.

Typically, the interaction between the market participants can take place via three conventional structures: conventional order matching, conventional market making, and conventional auctions. In conventional order matching, offers to buy and sell are centralized, typically in an exchange, and orders are filled by matching them with the complementary order. Individual participants can then buy or sell until an equilibrium for a particular contract is reached. Typically, the exchange takes no risk in the market. Inconventional market making, a market maker takes a position opposite to other market participants. Thus, a market maker may sell or buy contracts to other market participants.

In conventional auctions, a contract is typically offered for sale to any market participant. Conventional auctions can take a variety of forms. In certain conventional auctions, the contract is initially offered at a high price. The price is progressively lowered until a bid is made and the contract is sold. In conventional Dutch auctions, offers to buy are accumulated and the lowest price necessary to sell the entire lot of contracts becomes the price at which the contracts are sold. Mutualized risk pools can also be considered a form of auction. In a mutualized risk pool, market participants can choose to put money into a pool up until a cutoff time. When the pool closes, the money placed into the pool determines the prices of the contracts.

The relationships between buyers, sellers, and those who facilitate the market (e.g., market makers, exchanges, auction organizers, etc.) can be complex. For example, in the case of betting, individuals are usually limited to the role of making bets (i.e., purchasing contracts). The role of selling contracts is the province of the bookmaker. Furthermore, unnecessary uncertainty may be created in these relationships, which indirectly increases trading costs.

Although conventional structures allow transactions to take place and for the market to come to equilibrium, conventional structures also have drawbacks. For example, conventional structures may not result in a high degree of liquidity. Three typical measures of liquidity are the bid-offer spread, trading rate and price discovery. The bid-offer spread is the difference between the highest offer to buy (i.e., highest bid) and the lowest offer to sell (i.e., lowest offer) for a particular contract at a particular instant in time. It is an instantaneous measurement of liquidity. The higher the bid-offer spread, the lower the liquidity because the less likely it is that a market participant will be able to sell or buy the contract. The trading rate can be measured by the average time required to have an order for a contract filled or the volume of transactions for a given unit of time. The shorter the time required to fill an order and the higher the volume of transactions, the greater the liquidity and the easier it would be for a market participant to enter or leave the market. Price discovery is the ability to discover the true price of a contract in a market that has reached equilibrium. The easier it is to discover the price of a contract, the higher the liquidity.

Generally speaking, high liquidity is desirable. A higher liquidity allows the market participants to move in and out of the market more easily. In addition, exchanges desire a high liquidity because exchanges typically obtain a profit based upon the number of transactions carried out. Higher liquidity usually translates into a higher the number of transactions and therefore a greater profit for the exchange. Market makers desire a higher liquidity because a high liquidity translates to a higher number of transactions, lower risk for the market maker and a lower cost of borrowing capital for the market maker. Thus, it is desirable for a higher liquidity in the market place than may be available using the conventional structures.

Conventional order matching, market making and auctions also have other drawbacks. Conventional order matching often does not function well when there is an insufficient number of sellers that actually have contract(s) to sell, as opposed to a short seller. For example, there may be a disproportionate number of buyers without matching sellers. As a result, there will be lowered liquidity. In some situations, conventional market makers may actually have an incentive to reduce the competitive nature of the marketplace because the market maker may act to their own advantage, rather than to the advantage of the market as a whole. Conventional auctions can take time to organize and identify the winner(s) and, in the absence of sufficient offers, can fail to facilitate trading.

Moreover, conventional auctions generally can only be used in trading of single products but not related products. An example would be the Dutch auction where a single product of a fixed quantity is being sold, and the price of the lowest qualifying bid would be used as the price. As it stands, the Dutch auction cannot be applied to trading of financial products based on a continuous variable (e.g., an underlying stock price).

Accordingly, there is a need for mechanisms that increase the liquidity of markets and/or address the drawbacks of conventional auctions.

### SUMMARY OF THE INVENTION

One aspect of the present invention overcomes the limitations of the prior art by settling an auction of contracts as follows. The orders collected during the auction form an auction pool. An auction settlement price (ASP) for each contract is set. The ASPs can be based on the orders in the auction pool, or not. After the ASPs have been set, orders in the auction pool are filled (or not) based on the ASPs, and preferably also the aggressiveness of the order.

In another aspect of the invention, ASPs are set as follows. A subset of orders from the auction pool (it could be the entire auction pool) is selected to form a price setting pool. Prices are set based on the price setting pool. In some cases, these prices will be the final ASPs. In other cases, these prices will be intermediate prices referred to as implied contract prices (ICPs). The ICPs and the price setting pool are checked for consistency, for example to ensure that price limits for orders in the price setting pool are not violated by the ICPs. If there are no inconsistencies, the current ICPs are used as the ASPs. If there are inconsistencies, the price setting pool is adjusted, preferably giving priority to aggressive orders, and the ICPs are recalculated based on the adjusted price setting pool. The process is repeated until inconsistencies are removed.

In one approach, the price setting mechanism is based on mutualized risk pricing principles. This is well suited to orders based on total investment amount. In another approach, the price setting mechanism is based on Dutch auction pricing principles, which is well suited to orders based on quantities of contracts. These pricing mechanisms can also be used in cases without a separate quantity auction.

In another aspect of the invention, once the ASPs are set, orders are filled as follows. A qualified pool of orders is determined based on the ASPs. The qualified pool is the set of orders from the auction pool which are consistent with the ASPs. For example, an order to buy at a price lower than the ASP would not qualify. The qualified orders are ranked by some criteria, preferably aggressiveness. The orders are considered in rank order to form complete sets of orders (as will be discussed further below). Orders are filled generally based on whether they can be used to form complete sets.

Other aspects of the invention include different variations to address different types of contracts, and devices and systems corresponding to all of these methods.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1 (prior art) is a table showing different types of contracts.

FIGS. 2A-2E are payoff diagrams illustrating different complete sets of contracts.

FIGS. 3-4 are payoff diagrams illustrating different sets of basic units.

FIGS. 5A-5C are payoff diagrams illustrating the decomposition of a call spread into basic units.

FIG. 6 is a timeline of an auction according to the invention.

FIG. 7 is a flow diagram showing various methods for settling an auction according to the invention.

FIG. 8 is a table illustrating mutualized risk price setting.

FIG. 9A is a flow diagram of a mutualized risk based price auction, with price-limited orders.

FIG. 9B is a portion of a table ranking price-limited orders by aggressiveness.

FIGS. 10A-10C are tables illustrating a mutualized risk based price auction, with various methods for handling short positions.

FIG. 11 is tables illustrating conversion of short positions to equivalent long positions.

FIG. 12 is tables illustrating a mutualized risk based price auction, including CQ orders.

FIGS. 13-14 are tables illustrating a mutualized risk based price auction, including combination orders using different allocation policies.

FIG. 15 is a flow diagram of a mutualized risk based price auction accommodating different types of contracts.

FIG. 16A is a flow diagram of a Dutch auction based price auction, with price-limited orders.

FIG. 16B is a table illustrating a Dutch auction based price auction, with price-limited orders.

FIGS. 17A-17C are tables illustrating a Dutch auction based price auction, with buy and sell orders.

FIG. 18 is a flow diagram illustrating one method for determining the in pool from the qualified pool.

FIGS. 19A-19B are tables illustrating different ways to form complete sets from ranked orders.

FIG. 20 is a table illustrating a method for handling residual orders.

FIG. 21 is a block diagram of a computer system suitable for use with the present invention.

### DETAILED DESCRIPTION OF THE PREFERRED EMBODIMENTS

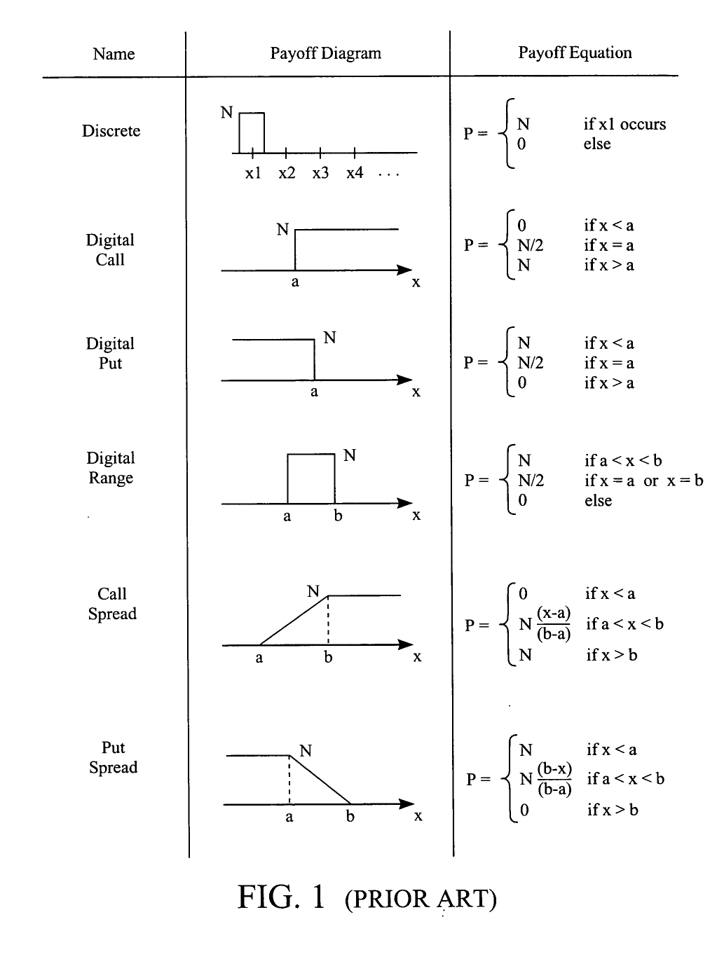

This invention relates generally to buying and selling contracts, particularly in the context of auctions. It is useful to begin with some underlying concepts, as illustrated in FIGS. 1-5.

FIG. 1 is a table showing the following types of contracts: discrete, digital call, digital put, digital range, call spread and put spread. In the table, the payoff diagram describes the payoff of a contract. The x-axis in the payoff diagram is the underlying event upon which the contract depends and the y-axis is the payoff. The payoff equation is a mathematical description of the payoff. The payoff function for a contract Cx shall be denoted as P(Cx). The columns “Payoff Diagram” and “Payoff Equation” are graphical and mathematical representations of P(Cx) for the specific contracts shown.

Some general remarks can be made about these contracts. First, note that the underlying event can be modeled as either discrete or continuous. It is discrete for the discrete contract and continuous for the other examples. The event can be modeled as discrete if there are a relatively small, finite number of possible outcomes. In the table, the possible outcomes are denoted as x1, x2, etc. It is more appropriately modeled as continuous if it is continuous or there are a large enough number of possible outcomes that it can be effectively modeled as continuous. In the table, the payoffs for the continuous cases depend on the value of a variable x. Note that events can be modeled as either discrete or continuous, depending on the content of the contract. In addition, the underlying events can be multi-dimensional, not just one-dimensional as shown in the table.

One example of a discrete event is a horse race, where the possible outcomes are x1: horse 1 wins, x2: horse 2 wins, etc. Another example is a sporting event where the possible outcomes are x1: Challenger wins the America's Cup or x2: Defender wins the America's Cup (assuming no ties). Another example is the stock market, with possible outcomes x1: certain index closes below Z or x2: at or above Z. Alternately, the outcomes might be x1: index closes below Z, x2: in the range between Z and Z+100, x3: in the range Z+100 to Z+200, x4: in the range Z+200 to Z+300, or x5: above Z+300 (ignoring boundaries for now).

One example of a continuous event is the price of an index. Another example would be the time margin of victory of horse 1 (although that example is not frequently used). A third example is the difference between the NFC champion's score and the AFC champion's score in the Super Bowl.

For continuous events, it can be important to handle boundary conditions correctly so that aberrations do not appear. In FIG. 1, discontinuous boundaries (such as for the digital put, digital call and digital range) are handled by taking the average of the two values. In this way, if the digital put and digital range contracts were combined, the payoff at x=a would be the notional N. In contrast, if the payoff function=N at all boundaries, then combining these two contracts would yield a payoff of 2N at the boundary x=a, which would be an undesirable anomaly. The boundaries can be handled in many ways. For example, the entire notional N can be allocated to one or the other of the contracts, so long as the sum was still N.

Also note that the payoff function can be either digital or not digital. A digital payoff function is one that can take on only two possible values (excluding boundary conditions). For example, the discrete, digital put, digital call and digital range contracts all have digital payoff functions: either 0 or the notional N. The two spreads have proportional payoffs, at least in the range of a<x<b. The call spread has a diverging slope (i.e., payoff increases as x increases) and the put spread has a converging slope (i.e., payoff decreases as x increases).

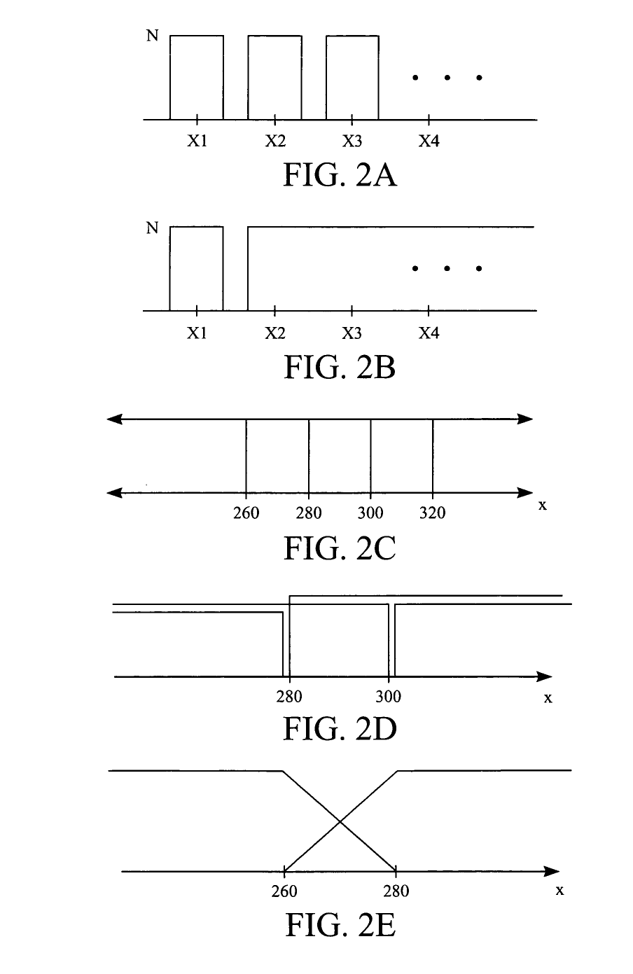

FIGS. 2A-2E illustrate the concept of complete sets. When someone holds a contract Cx, his payoff for that particular contact is P(Cx). When someone holds a set of contracts, the aggregate payoff for that set of contracts is the sum of the individual payoffs for each contract. A complete set of contracts is a set of contracts for which the aggregate payoff is a constant. This constant shall be referred to as the settlement value (SV) of the complete set. Mathematically, a set of contracts {Cn} is a complete set if

ΣP(Cn)=SV for all possible outcomes (1A)

where the summation is over all contracts n in the set. Graphically, the payoff diagram for a complete set is a constant line at payoff SV. Since the payoff diagram of a complete set is a constant value SV, the “fair market” price of a complete set (ignoring time value of money and transaction costs for now) is also SV. In other words,

ΣPrice(Cn)=SV (1B)

where Price(Cn) is the price of contract Cn. The actual prices for the contracts may vary.

FIG. 2A shows a complete set for the discrete case. The possible outcomes are x1, x2, etc., which are assumed to be mutually exclusive and collectively exhaustive. In other words, one and only one of the outcomes x1, x2, etc. must occur. The complete set is the set of contracts Cx1, Cx2, etc. covering all possible outcomes where each of these contracts has the same notional. In this way, regardless of which outcome occurs, the holder of the complete set will receive a payoff equal to the notional. It is like betting on both black and red in roulette (assuming no 0 or 00). As another example, if the event is a horse race, then the set of wagers that pays $10 if horse 1 wins, $10 if horse 2 wins, etc. is a complete set.

Complete sets can be formed in more than one way. FIG. 2B shows a different complete set for the discrete case. In this example, the complete set contains two contracts: Cx1 and C(not x1). C(not x1) pays the notional if any of x2, x3, etc. occur. Note that the contract C(not x1) is equivalent to the set of contracts {Cx2, Cx3, etc.} and the payoffs and fair market prices are related:

P(C(not x1))=P(Cx2)+P(Cx3)+ (2A)

Price(C(not x1))=Price(Cx2)+Price(Cx3)+ (2B)

Combining Eqns. 1B and 2B yields

Price(Cx1)=SV−Price(C(not x1)) (3A)

In other words, an offer to sell Cx1 at price Z or higher is equivalent in aggressiveness to an offer to buy C(not x1) at price (SV−Z) or lower. These concepts can be used to convert between short and long positions, as will be discussed in more detail below.

FIG. 2C is an example of a complete set for a continuous case. In this example, the complete set includes a digital put with upper bound x=260, three digital ranges that cover the range 260<x<320 in 20 point increments, and a digital call with lower bound x=320. All contracts have the same notional. Regardless of the value of x, the holder of the complete set will be entitled to receive a payoff equal to the notional. Note that the boundary conditions must be handled properly so that the payoff diagram of the complete set does not vary from the notional at the boundaries.

FIG. 2D is an example of a complete set formed by overlapping contracts. The boundaries are slightly shifted so the different contracts can be more clearly seen. In this case, the complete set includes three contracts: a digital put with upper bound 300 and notional N, a digital call with lower bound 280 and notional N, and a contract that is not (digital range of 280/300). This last contract has two pieces. The sum of the three contracts is a complete set with SV=2 N. In this example, the contracts are not mutually exclusive. For example, an outcome of x=282 will result in a payoff for both the digital call and the digital put.

FIG. 2E is an example of a complete set using non-digital payoff functions. In this example, a call spread and a put spread form a complete set. Both spreads are proportional in the range 260<x<280 and have the same notionals. Thus, the sum of the payoff diagrams is a constant with settlement value equal to the notional.

FIGS. 2A-2E are merely examples. Complete sets can be formed in many different ways. However, it is important to recall that a complete set of contracts will pay the settlement value regardless of the outcome of the underlying event. Thus, the fair market price for the complete set is its settlement value. As an example, assume three possible outcomes x1, x2 and x3. Further assume that each of the corresponding contracts Cx1, Cx2, Cx3 has a notional of $100. Then the set of three contracts Cx1, Cx2, Cx3 forms a complete set with SV=$100. Accordingly, if there is an opportunity to buy Cx1 for $50, Cx2 for $30 and Cx3 for $19 (or a total of $99), this is an opportunity to buy the complete set, which is worth $100, for only $99. It is a $1 arbitrage opportunity. Conversely, if there is an opportunity to sell Cx1 for $51, Cx2 for $31 and Cx3 for $19 (or a total of $101), this is an opportunity to sell a $100 complete set for $101. These are simple examples to illustrate the point. More complex examples, including taking advantage of the long/short equivalence described above, will be described in more detail below.

Put in another way, if a market organizer (or anyone else) buys just Cx1, it will be taking some contract risk depending on whether x1 occurs or not. However, if the organizer buys or sells a complete set at price SV, the organizer will not be taking any contract risk because the two are equivalent. Thus, the organizer can buy and sell complete sets for other purposes, for example to increase the liquidity of the market or reduce credit risk. For further examples of how this can be accomplished, see co-pending U.S. patent application Ser. No. ______ (attorney docket no. 2700P), entitled “Method and System for Utilizing a Special Purpose Vehicle for Improving the Liquidity of Transactions,” filed on even date herewith; and copending U.S. patent application Ser. No. (attorney docket no. 2701P), entitled “Method and System for Managing Credit-related and Exchange Rate-related Risk,” filed on even date herewith.

The discussion thus far has also neglected certain other effects. For example, the time value of money has not been factored into the discussion. A payoff of $100 that occurs a year from now (e.g., when the underlying event is resolved) is not really worth $100 today. The discussion also does not account for transaction costs. However, these and other factors can be handled using conventional techniques. Standard present value concepts can be used to account for the time value of money, allowing direct comparison of dollar figures. For example, Eqn. 1B states that the fair market price of a complete set should be the settlement value. However, if the payoff will occur one year from now, then, more precisely, the fair market price today of a complete set should be the settlement value, as measured in dollars one year from now, discounted by the annual interest rate. Or if the equation is cast in future dollars, then the fair market price today of a complete set, after interest for a year, should be equal to the settlement value, measured in future dollars. Similarly, amounts can be adjusted up or down, as necessary, in order to account for transaction costs, profit or other effects. For example, if a minimum profit Z is required, then the sum of the prices of the contracts in the complete set should be (SV−Z) or lower to yield profit Z for the buyer, or (SV+Z) or higher to yield profit Z for the seller. In the interest of clarity, all examples will continue to neglect these factors, with the understanding that they can be handled using conventional techniques. For further examples and discussion, see co-pending U.S. patent application Ser. No. ______ (attorney docket no. 2626P), entitled “Method and System for Improving the Liquidity of Transactions,” filed on even date herewith; co-pending U.S. patent application Ser. No. ______ (attorney docket no. 2700P), entitled “Method and System for Utilizing a Special Purpose Vehicle for Improving the Liquidity of Transactions,” filed on even date herewith; and co-pending U.S. patent application Ser. No. ______ (attorney docket no. 2701P), entitled “Method and System for Managing Credit-related and Exchange Rate-related Risk,” filed on even date herewith; all of which are incorporated by reference herein. Note that in these referenced patent applications, the term “initial settlement value” is used to refer to the settlement value when the events occur (i.e., when the contracts mature) and “settlement value” is used to refer to other time frames, so that time discounting may be required to equate the current settlement value with the initial settlement value.

As shown in FIGS. 2A-2E, complete sets can be formed in many different ways. In order to facilitate the formation of complete sets, it can be useful to define a special set of contracts, which shall be referred to as basic units. In many markets, the contracts traded in that market can take many different forms. They can also be quite complex. It can be difficult to try to assemble these “native” contracts into complete sets. As an alternative, the native contracts can be decomposed into an equivalent combination of basic units and complete sets are then formed using the basic units.

There can be many choices for the set of basic units. However, in many cases it is advantageous for the basic units to be mutually exclusive and collectively exhaustive. In this case, it will be simpler to decompose the native contracts into basic units, and it will also be simpler to form the basic units into complete sets. However, it is not required for the set of basic units to be mutually exclusive, although it preferably is collectively exhaustive in order to decompose all possible native contracts. The set of basic units preferably should also have the correct shapes to match all possible native contracts.

In the discrete case of events x1, x2, etc., one good choice of basic units is Cx1, Cx2, etc. where all contracts have the same notional. This set of basic units is both mutually exclusive and collectively exhaustive. Furthermore, in many discrete cases, the “native” contracts are simply single event contracts (e.g., Cx5) so that each native contract is a basic unit. In cases where more complex native contracts are used, the decomposition into basic units is straightforward.

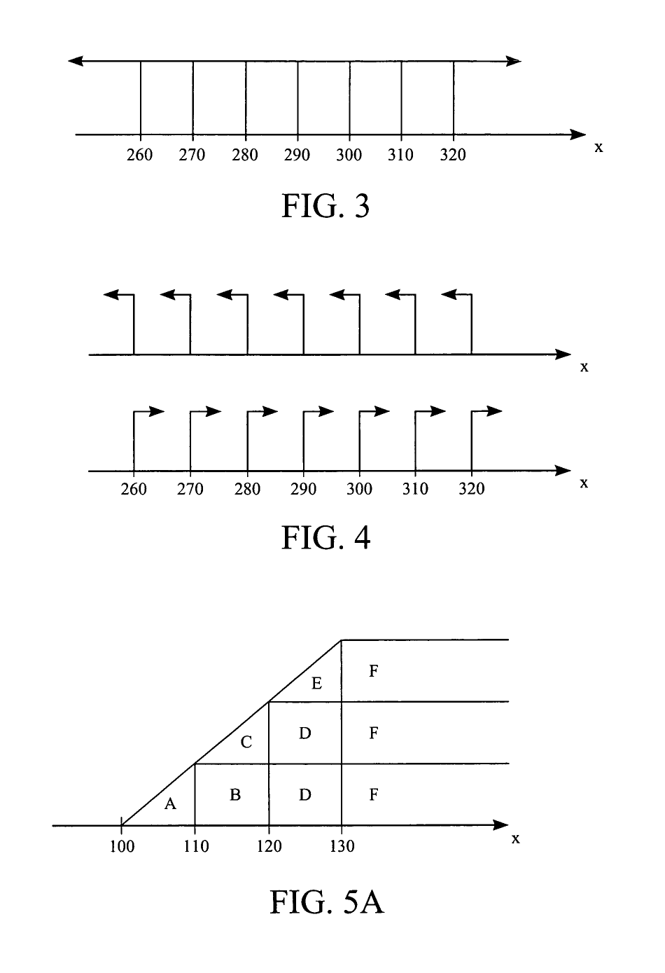

FIG. 3 shows a set of basic units for a case where the underlying event x is continuous but the payoff diagrams are all digital. The set of basic units is the digital put with boundary 260, the set of 6 digital ranges shown, and the digital call with boundary 320. All basic units have the same notional. This set of basic units can be used to decompose any native contract that has a digital payoff with boundaries at 260, 270, . . . 320.

The set of basic units can change over time. For example, if x approaches the upper end of the range, the set can be expanded to include more digital ranges at the high end. In addition, digital ranges at the low end can be decommissioned, with a corresponding change in the digital put. Alternately, if finer ranges are desired, the current digital ranges can be subdivided, for example using digital ranges with a span of 2 units instead of 10. The spans also are not required to be identical. When making these changes, it is preferable to select a new set of basic units that is backwards compatible with the old set.

FIG. 4 shows a set of basic units that are based on digital calls and digital puts, all with the same notional. Note that this set is not mutually exclusive. However, it can also be used to decompose any native contract that has a digital payoff with boundaries at 260, 270, . . . 320.

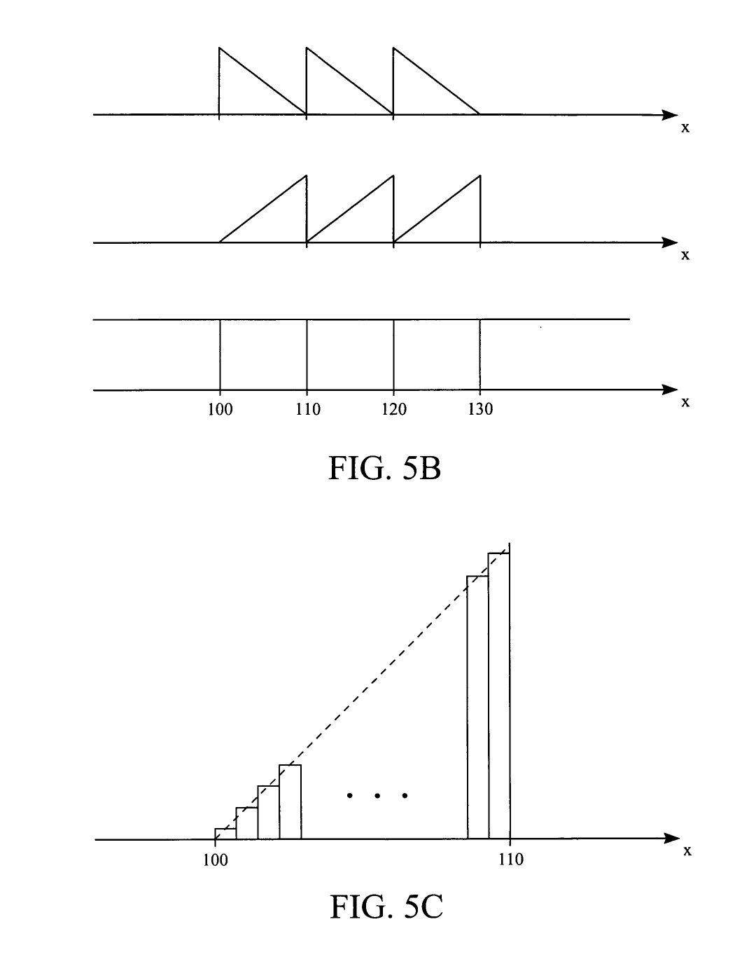

FIG. 5A illustrates the decomposition of a call spread into the following basic units: a diverging slope of 100/110 (the triangular region marked A), a digital range of 110/120 (rectangle B), a diverging slope of 110/120 (C), two digital ranges of 120/130 (D), a diverging slope of 120/130 (E), and three digital calls at 130 (F). All basic units have the same notional. More generally, if corresponding converging and diverging slopes are added to the set of basic units shown in FIGS. 3 or 4, then call spreads and put spreads can also be decomposed into basic units.

FIG. 5B shows a set of basic units that can be used to decompose the call spread in FIG. 5A. This set includes a digital put 100, a digital call 130, three digital ranges spanning 100/130, three converging basic units spanning 100/130, and three diverging basic units spanning 100/130. This set of basic units can be used to decompose any of the continuous contracts shown in FIG. 1, so long as the boundaries match those of the basic units (i.e., a and b must be 100, 110, 120 or 130). Note that in addition to the complete set Eqns. 1-3 above, the relationships of the basic units also imply additional constraints. For example, the digital range 100/110 is equivalent to the sum of a converging 100/110 and a diverging 100/110. Therefore,

Price(converging 100/110)+Price(diverging 100/110)=Price (range 100/110) (3B)

Thus, within this group of three basic units, there are really only two independent basic units with respect to fair market price. If the fair market prices of two of the basic units are known, then the fair market price of the third can be calculated by Eqn. 3B. An analogous situation exists for other relationships.

FIG. 5C shows an alternate set of basic units. Rather than using the triangular shaped converging and diverging basic units, a series of rectangular “sub” basic units is used to approximate the proportional payoff diagram. FIG. 5C shows the approximation of a diverging 100/110. The converging 100/110 would be approximated by the complimentary set of rectangular units, so that the two sets would sum to the notional. In many cases, the underlying variable x is not truly continuous. For example, it may have a tick value that is the smallest increment of x. In this case, the rectangular “approximation” becomes exact if the width of the rectangles equals the tick value. Alternatively, the triangular basic unit can be treated as a rectangular unit for purposes of price setting; the result is often the same as the infinite rectangular case if market-driven allocation (as described below) is used.

The above are merely examples. For further examples of how to select a set of basic units, see co-pending U.S. patent application Ser. No. ______ (attorney docket no. 2626P), entitled “Method and System for Improving the Liquidity of Transactions,” filed on even date herewith and incorporated by reference.

The concepts of basic units can be important because they allow markets with many different types of contracts to be decomposed into basic units, which can then be used to facilitate the formation of complete sets. All of the following examples will be illustrated using discrete contracts with only a few possible outcomes, typically three to five. In many of these cases, the set of basic units will simply be {Cx1, Cx2 . . . Cx5}. This is done for clarity. Otherwise, the examples will involve so many numbers as to obscure the point being illustrated. However, by using the concept of basic units, these simple examples can be extended to complex markets with many different types of contracts.

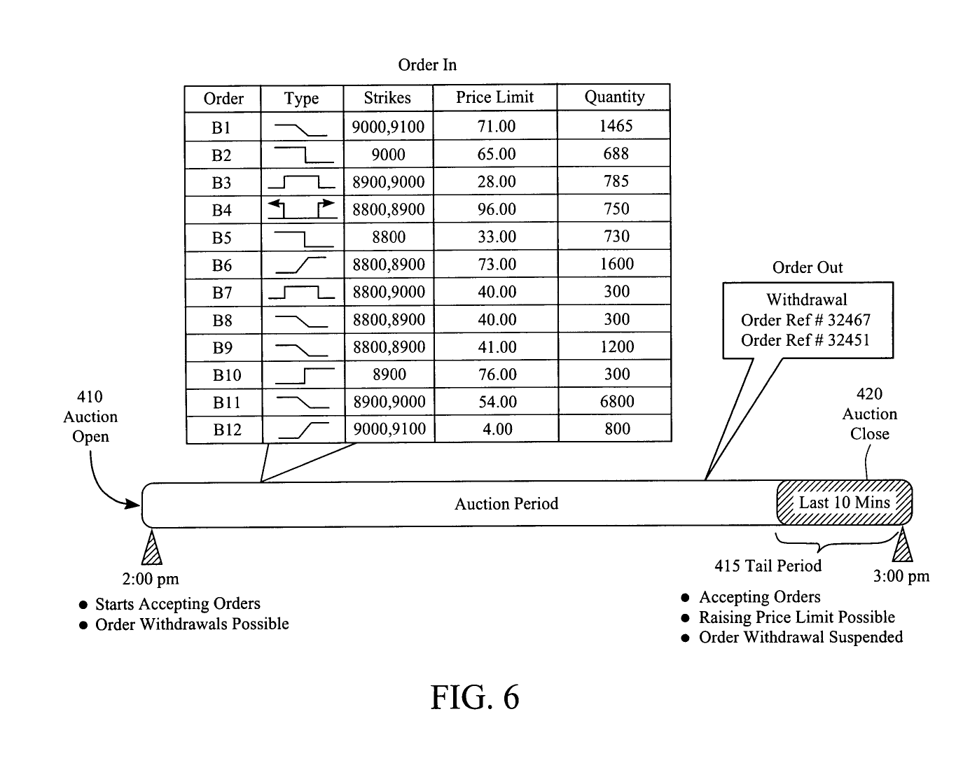

Let us now turn to auctions. FIG. 6 is an example timeline of an auction. At time 410 (2:00 pm in this example), the auction opens and begins accepting orders for contracts. Typically, the auction organizer will define the types of contracts that are supported by the auction. The auction continues for some period of time and then closes 420 (at 3:00 pm in this example), after which orders are no longer accepted. In the specific example of FIG. 6, there is also a tail period 415 where orders can no longer be withdrawn. At some point, the auction is settled, meaning that the pool of pending orders are filled (or not). The events underlying the contract typically occur after the auction both closes 420 and settles.

Settlement of the auction can occur in a number of ways. In conventional approaches, the prices of the contracts and which orders are to be filled (i.e., quantity) are determined simultaneously as part of the settlement process. However, in one aspect of the invention, the determination of price and quantity are separated.

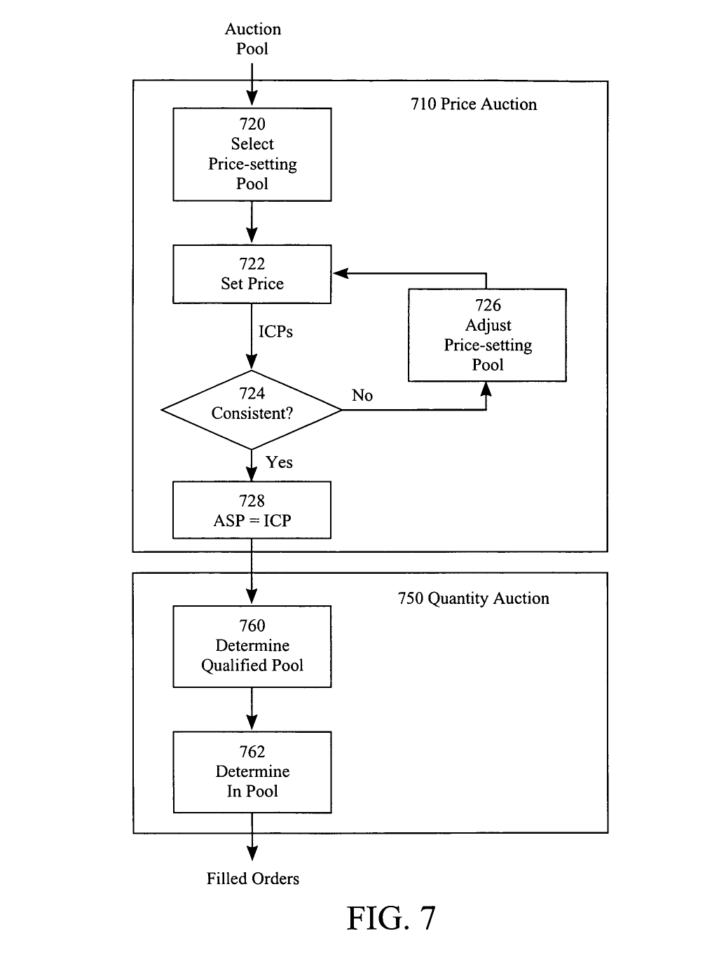

FIG. 7 shows various examples of this approach. In this aspect of the invention, the prices of the contracts are determined 710 first. These prices shall be referred to as the auction settlement prices (ASPs). Then, orders are filled 750 (or not), given the ASPs. For convenience, the first step 710 will sometimes be referred to as the price auction and the second step 750 as the quantity auction.

In one approach to the price auction 710, the ASPs preferably are set based on the pool of orders collected during the auction (also referred to as the auction pool). For example, the ASPs can be set in a manner that reflects the demand in the auction pool. Typically, a single ASP is set for each contract (i.e., no discriminatory pricing). Once the ASPs are set, the quantity auction 750 preferably fills orders according to some ranking criteria of the available orders. For example, the orders can be ranked based on price aggressiveness, with the most aggressive orders filled first when possible. That is, orders that offer to buy at higher prices or offer to sell at lower prices would be filled before others.

The interior of boxes 710 and 750 illustrate specific examples of price auction and quantity auction. The price auction example operates as follows. First, a price setting pool is selected 720 based on the auction pool. Typically, the price setting pool will be a subset of orders from the auction pool (it could be the entire auction pool). Prices are then set 722 based on the price setting pool. In some cases, these prices will be the ASPs. However, the example in FIG. 7 shows an iterative loop and these intermediate prices are referred to as the implied contract prices (ICPs). In the iterative case, ICPs and the price setting pool are checked 724 for consistency. For example, if the ICP for Cx1 is $20 and the price setting pool was formed assuming a price of $21, then this is inconsistent. If there is inconsistency, the loop is repeated. The price setting pool is adjusted 726, taking into account the current ICP, and then new ICPs are calculated 722 based on the new price setting pool. This loop continues until the ICPs and the price setting pool are consistent, in which case the ICPs are then used 728 as the ASPs. Note that the price setting pool is used to determine the ASPs; no trades are actually executed at this point.

The quantity auction example operates as follows. There are three pools: the auction pool, the qualified pool and the in pool. The auction pool is the collection of orders received for the auction. The auction pool is processed 760 to define the qualified pool, which is the collection of orders that meet the ASPs determined in the price auction. For example, if the ASP for buying Cx1 is set at $72 and an order has a maximum offer price of $69, that order will not qualify. In some cases, the qualified pool may be generated automatically as a part of the price auction.

Once the qualified pool is determined, it is processed 762 to determine the in pool. The in pool is the set of orders that are actually filled at the ASP. Orders preferably are filled by aggressiveness priority. The aggressiveness of an order can be determined based upon the price (higher prices are more aggressive for buy orders and lower prices are more aggressive for sell orders), quantity (larger quantities are more aggressive), time chop (earlier orders are more aggressive), other characteristics of the order, or some combination thereof. Consequently, some heuristic previously defined by the organizer (e.g. price) is preferably used to determine the aggressiveness of orders. The price auction can also take aggressiveness into account in determining the ASPs.

In addition, filling orders in complete sets reduces or eliminates contract risk for the auction organizer. The in pool may be different from the qualified pool because it is possible that not all qualified orders will be filled. For example, if the orders in the qualified pool cannot be combined in a manner that forms only complete sets, then there will be some residual unmatched orders in the qualified pool. These can be handled in a number of ways. For example, the organizer can take some contract risk by entering the market to form complete sets with these residuals. Alternately, the residual orders may simply go unfilled. Alternately, the organizer may form complete sets by matching residual orders with otherwise unqualified orders. Note that in this last example, the in pool will contain orders that are not in the qualified pool. The organizer may subsidize these unqualified orders in order to fill them.

In the following examples, the orders typically will be either investment amount (IA) orders or contract quantity (CQ) orders. Generally speaking, they can also be either offers to buy (longs) or to sell (shorts). Assume for the moment that the orders are for Cx1 with a notional of $100.

An IA order is defined by a total dollar amount that the buyer is willing to buy. For example, an IA $50x1 means that the buyer is offering to buy $50 worth of Cx1. IA orders can have price limits. Price limits for IA orders are often defined by a mutualized risk price ratio (MRPR), which is the notional divided by the price of the contract. So, an IA $50x1, MRPR 4 means that the buyer is offering to buy $50 worth of Cx1 but only if the price is $100/4=$25 or less. Equivalently, the buyer is offering to buy $50 worth of Cx1 but only if he receives $50/$25=2 or more units of Cx1. IA combination orders can also be made. An IA $50(x1 and x2) means that the buyer is offering to buy a total of $50 worth of Cx1 and Cx2. The allocation of the $50 between Cx1 and Cx2 will be determined by the allocation policy, which will be discussed in greater detail below. Note that the combination order is not two separate offers, one for x1 and one for x2. Rather, it is an offer to buy a combination of x1 and x2 in some specific ratio, the ratio being determined by the order.

CQ orders are defined by quantity. A CQ 10x1 means that the buyer is offering to buy 10 units of Cx1. CQ orders typically come with a price limit, which typically limits the highest price the buyer is willing to pay for those units, for example CQ 10x1, price $25. Combination orders are also possible. A CQ 10(x1 and 2x2) means the buyer is willing to buy 10 Cx1 and 20 Cx2 together. The price limit for a combination order applies to the total price for the combination. In this example, the price limit would be the most the buyer is willing to pay for 1 Cx1 and 2 Cx2.

Note that there is a relationship between IA and CQ orders based on the equation

Investment Amount=Contract Quantity×Price (4)

For example, once the ASP is determined, an IA $50x1, price $25 is equivalent to a CQ order with the same price limit, where the quantity equals the notional/ASP (or a minimum quantity of notional/$25 due to the price limit). CQ orders can also be converted to equivalent IA orders. For example, a CQ 10x1, price $25 is equivalent to an IA order with the same price limit, where the investment amount is 10×ASP (or a maximum of $250 due to the price limit).

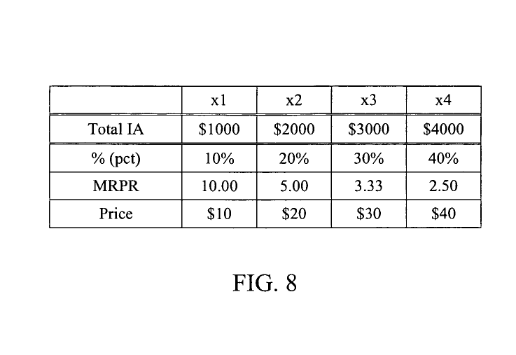

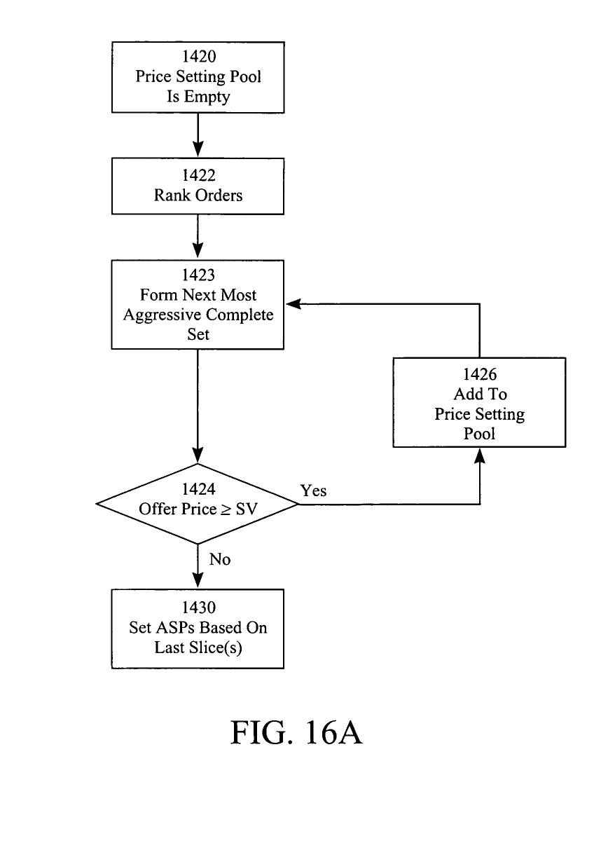

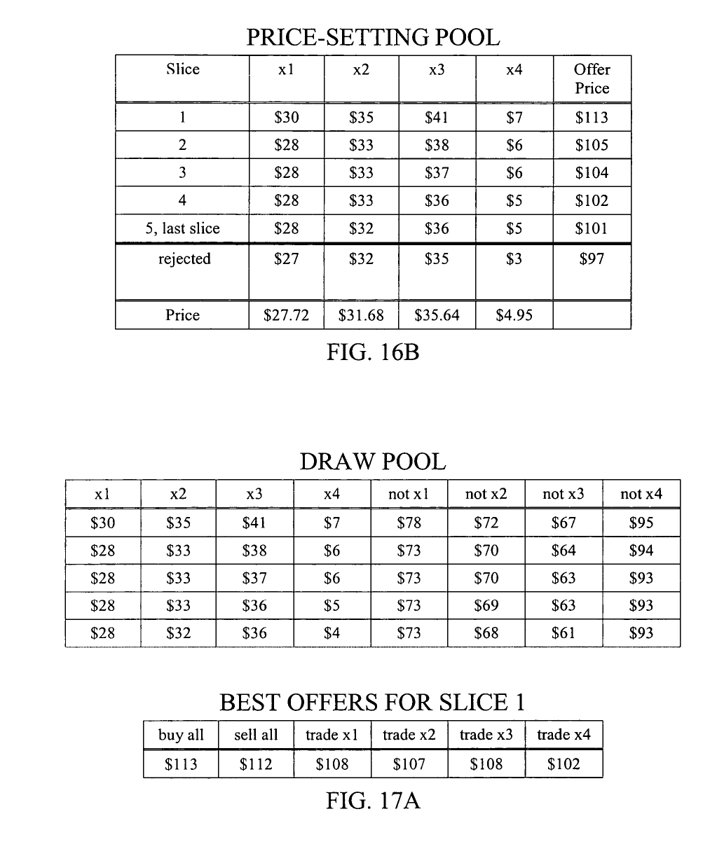

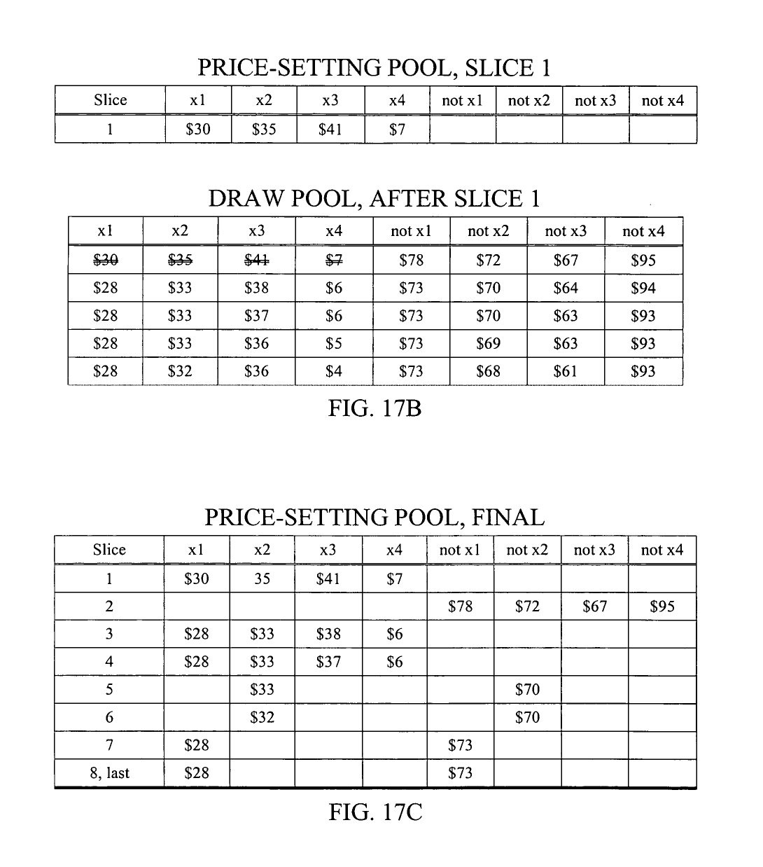

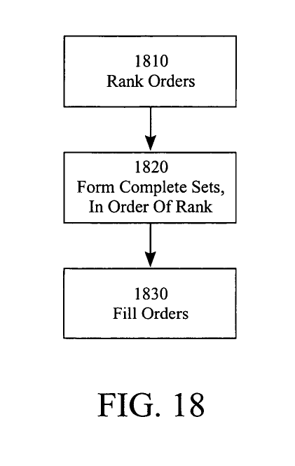

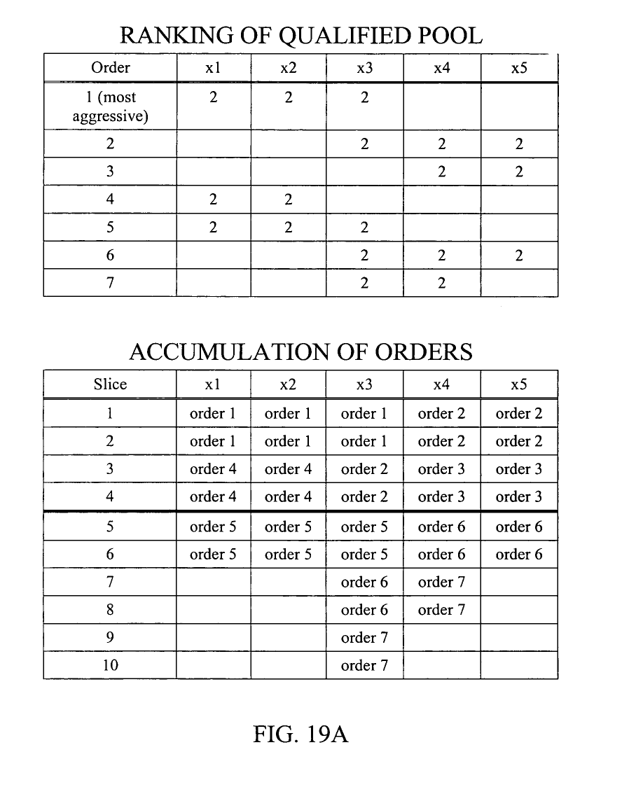

The general task addressed by FIG. 7, then, is given an auction pool of IA and/or CQ orders that have been collected during the auction period, how can the ASPs be determined 710 and, given the ASPs, how can the quantities then be determined 750. FIGS. 8-17 describe different types of price auctions. In FIGS. 8-15, the price setting mechanism 722 is based on mutualized risk concepts and in FIGS. 16-17 it is based on Dutch auction concepts. The emphasis in these figures is on selecting 720, 726 the price setting pool. FIGS. 18-20 describe different types of quantity auctions, generally based on prioritizing orders according to their aggressiveness and then forming complete sets from the prioritized orders. These figures mostly emphasize the handling of combination orders.

The different approaches to price auction and quantity auction are introduced below in the context of FIG. 7, where a price auction is followed by a quantity auction. However, they are also useful in their own right. For example, the various price setting mechanisms can be used regardless of whether there is a separate quantity auction, or even any quantity auction at all. The same holds true for the different approaches to quantity auction.

FIG. 8 illustrates the basic mutualized risk price setting mechanism. Assume for the moment that all orders are IA, no price limit, no shorts, and no combinations. Then, the ASP is determined as follows. The row “Total IA” is the total investment amount across all orders for each outcome. For example, $1000 is the total investment amount for x1, $2000 for x2, etc. For this example, it does not matter if the $1000 for x1 comes from one order or a thousand orders. The total pool of investment across all outcomes is $10,000. The next row “% (pct)” shows the percentage of the total investment pool represented by each outcome. The $1000 for x1 is 10% of the total pool, etc. “MRPR” is the mutualized risk payoff ratio. It is the total pool divided by the pool for the outcome (e.g., $10,000/$1000=10) for x1. The final row is the price for Cxn, assuming a notional of $100. Note that the pct, MRPR, price and notional have the following relationships:

Price=Notional/MRPR (5A)

Price=Notional×pct (5B)

MRPR=1/pct (5C)

Also note that since Cx1, . . . Cx4 is a complete set, it is known that the sum of the contract prices is the notional. The mutualized risk price setting mechanism is a mechanism for allocating the $100 notional among the four basic units—specifically, in proportion to pct.

Note that FIG. 8 is mutualized risk price setting based on investment amount, but the same concept can also be used with other parameters. For example, if the orders were CQ orders, mutualized risk price setting could be used based on total quantity rather than total investment amount. The pct for x1 would be calculated as the quantity ordered for x1 divided by the total quantity ordered for the entire pool. Mutualized risk price setting can also be used with short orders; the IAs would be based on amounts being offered for sale rather than amounts being offered for purchase purposes.

FIG. 8 illustrates mutualized risk price setting. The majority of the following mutualized risk examples concern step 720, 726—how to select the price setting pool. In FIG. 8, the auction pool and the price setting pool were the same. However, when more complex contracts are considered, the two can be different. In the following examples, once the price setting pool is selected, mutualized risk price setting is used with respect to the price setting pool, not the auction pool, to determine 722 the ICPs/ASPs. The following figures consider each of the following contract variations in turn: price limits, short orders, addition of CQ orders, and combination orders. The principles shown in these figures can be combined to handle auctions with different combinations of these variations.

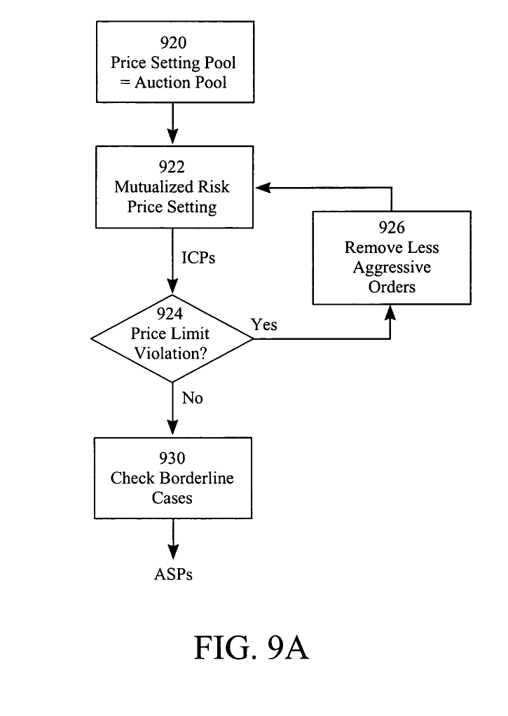

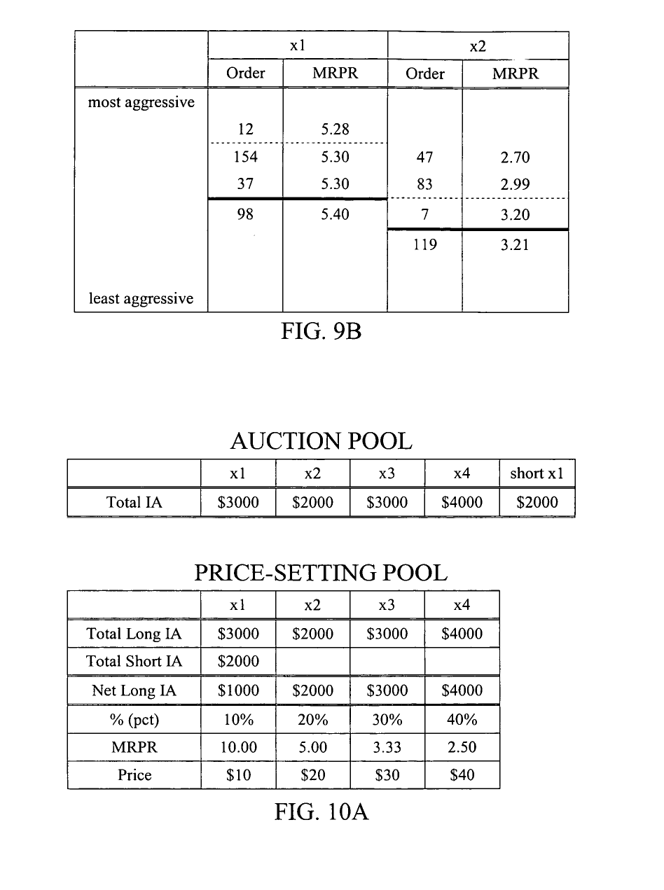

FIG. 9A illustrates one way to handle price limits. In this example, the auction pool contains the most basic IA orders (i.e., no CQ orders, no shorts, and no combinations) but some of the orders may have price limits. The price auction proceeds as follows. Initially, the entire auction pool is used 920 as the price setting pool. Mutualized risk price setting (as described in FIG. 8) is used to determine 922 ICPs. These ICPs are compared 924 to the orders in the price setting pool to see if any price limits have been violated. If price limits are violated, then less aggressive orders in the price setting pool are removed 926 (either partially or entirely) from the price setting pool. The pool is repriced 922 and the loop is repeated until no price limits are violated. The final ICPs are used as the ASPs. Optionally, when the loop is exited, borderline orders can be checked 930 to see if they can be reinstated into the price setting pool (either in whole or in part) without violating their price limits.

In one implementation, the orders for each basic unit are ranked by order of aggressiveness so that steps 924 and 926 can be performed more efficiently. Aggressiveness typically is measured by the price limit. For buy orders, higher price limits (or, equivalently, lower MRPR limits) are more aggressive. For sell orders, lower price limits (or, equivalently, higher MRPR limits) are more aggressive. If some orders have price limits expressed in dollars and others in MRPR, it is useful to convert the price limits to a common measure (e.g., MRPR) to facilitate comparison. This can be done using Eqns. 5A-5C.

FIG. 9B shows an example of this. The orders are ranked in order of decreasing aggressiveness (increasing MRPR) for each of x1, x2, etc. For x1, order 12 has a MRPR limit of 5.28, order 154 a limit of 5.30, etc. A similar list exists for x2. Orders above the solid line are included in the current price setting pool. Thus, orders 98 and 119 are not used in the mutualized risk price setting, having been eliminated from the price setting pool in earlier rounds. The current ICPs for x1 and x2 are shown by the dashed lines. Orders 154 and 37 are not aggressive enough to meet the current ICP for x1, and likewise for order 7 for x2. The ranked list simplifies the task of determining 924 whether any price limits have been violated.

In step 926, some of the violated orders are removed from the price setting pool. This can be done in many different ways. For example, all violated orders (154, 37 and 7) could be removed simultaneously. Alternately, only the least aggressive violated order might be removed. Different measures can be used to determine which order is the least aggressive. Percentage difference between an order's MRPR and the current MRPR (based on the current ICP) is one measure; absolute difference is another measure; differences based on dollar price rather than MRPR are another measure. In case of ties, factors such as time chop (i.e., when the order was submitted) or creditworthiness of the order can also be used to rank the orders.

As another example, the least aggressive order could be identified and then orders are removed from that particular basic unit until there are no more violating orders. For example, assume that order 154 was the least aggressive order. Then, orders for x1 are removed from the price setting pool until the ICP for x1 rises to a level where no remaining orders are violated. Other variations will be apparent. Regardless of the specific method, the end result is a price setting pool that is consistent with the ICPS, which are then used as the ASPs.

Note that this document will often refer to operations performed on orders or basic units, such as the process of eliminating orders described above. It should be understood that this is meant to include portions of orders as well as entire orders. For example, assume that order 154 above had an IA of $1000. Instead of removing the entire $1000 from the price setting pool, a portion of the order could be removed. This can be done in a number of ways. For example, the IA to be removed could be based on a fixed amount (e.g., $100 on each iteration), or a fixed percentage of the original IA amount (e.g., 20% of the original $1000 on each iteration), or a percentage of the current IA in the price setting pool (e.g., 15% of the current IA amount), and so on. Closed form solutions may also be possible, depending on the complexity of the price setting pool.

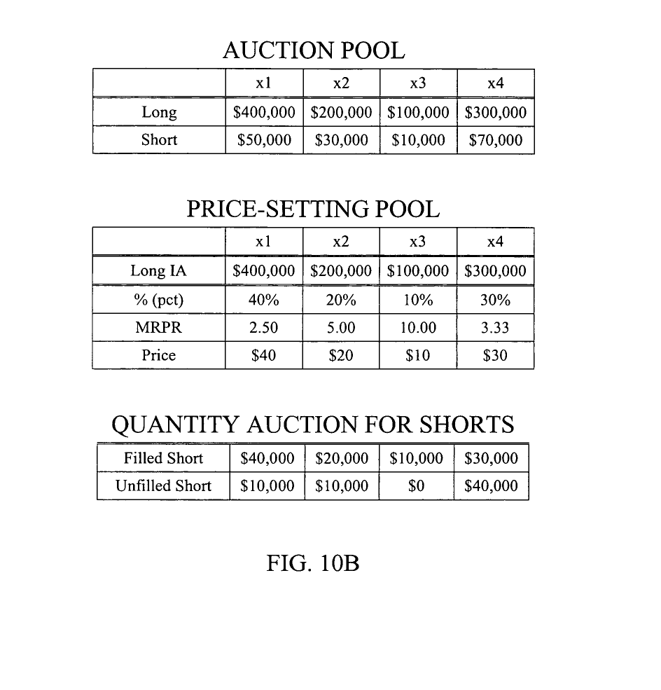

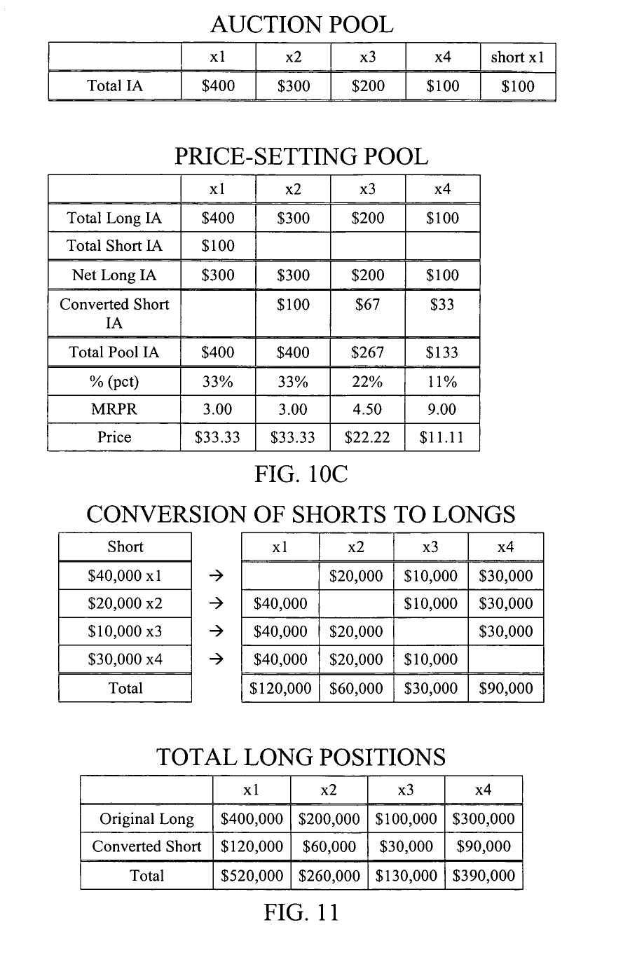

Now consider the situation where there is a combination of long and short orders. Assume for the moment that there is a net long position. The shorts can be handled in a number of ways, two examples of which will be discussed below. In one approach, shorts and longs are netted to yield a net long position and the net long position is used for the price setting pool. FIG. 10A shows an example. In the auction pool, the row “Total IA” is the total IA across all orders of a specific type: $3000 for x1, $2000 for x2, etc. and $2000 for short x1. In the price setting pool, the short and long positions of x1 are netted to yield the row “Net Long IA:” $1000 for x1, $2000 for x2, etc. These are the IAs to which mutualized risk price setting is applied, yielding the pct, MRPR and price (assuming $100 notional) shown in FIG. 10A. If the shorts in a particular basic unit would yield a net short position, this can be handled in several ways. One approach is simply to remove short orders from the price setting pool until there is a net long position. Preferably, the rejection will be based on aggressiveness—less aggressive short orders will be rejected before more aggressive ones.

Another approach for handling shorts is to simply ignore them for price setting purposes. In some instances, short selling may have negative connotations. An organizer may want to run an auction solely on the basis of long positions, but still accommodate short positions to the extent that he can without upsetting the claim that the auction is based solely on longs.

FIG. 10B shows one way to achieve this. Basically, the price setting pool is based solely on the long positions and this sets the ASPs. Once the ASPs are set, short positions are accepted only to the extent they form complete sets. In the example shown, the auction pool has both long and short orders for all basic units x1-x4. However, the price setting pool is based strictly on the long positions, resulting in the ASPs shown. In the quantity auction, the short orders are accommodated to the extent that complete sets can be formed. They will be accepted on a pro-rata basis according to the pct in the price setting pool. In this example, the quantity of filled short orders is shown in FIG. 10B and is limited by the $10,000 short position in x3. Under this scenario, short orders may go unfilled, as shown. Preferably, orders are filled in order of aggressiveness.

FIG. 10C illustrates a third way to handle short positions. In this example, the auction pool includes a $100 short position in x1. The price is set by adding the short position as an equivalent long position, but using the pricing based on the net long position. In the price setting pool, the row “Net Long IA” shows the net long positions. Note that the $100 short in x1 is used to reduce the $400 long position in x1. The $100 short position is converted to an equivalent long position, based on the Net Long IA. It is then added to the Original Long IA to yield the total pool. Pricing is calculated based on the total pool, as shown.

Regardless of how shorts are treated for price setting purposes, once the ASPs are set, any unconverted shorts can be converted to an equivalent long position. Recall that a short position in x1 is equivalent to a long position in (not x1)—i.e., a long position in x2, x3 and x4. Continuing the example of FIG. 10B, the filled shorts are converted to long positions as shown in “Conversion of Shorts to Longs” in FIG. 11. For example, the $40,000 short position in x1 is converted to $20,000x2, $10,000x3 and $30,000x4. The total long positions resulting from conversion of the short positions is $120,000x1, $60,000x2, $30,000x3, and $90,000x4, as shown in the row “Converted Short” in the table “Total Long Positions.” Note that this is a complete set. This can be added to the original long position of FIG. 10B to yield the total pool for this auction: $520,000x1, etc. Converting the shorts to longs increases the liquidity of the overall pool.

Price limits on short positions can be handled the same way as described above for long positions. If shorts participate in the price setting pool, then, referring to FIG. 9A, they can also be checked for violation of their price limits in step 924 and the price setting pool then adjusted accordingly. As with long positions, the “aggressiveness” of a price limit in a short position can be measured in many different ways, including but not limited to comparison with the current MRPR,comparison with the current ICP, on absolute terms, on a percentage basis, on the basis of the short position itself, or on the basis of the equivalent long position (e.g., a short position to sell x1 at $23 is equivalent to a long position to buy (not x1) at $77, assuming a $100 notional).

The discussion above was cast in terms of handling short positions where the auction pool primarily contains long positions. It is basically long-order based. The principles shown apply equally to handling long positions using short-order based where the auction pool primarily contains short positions.

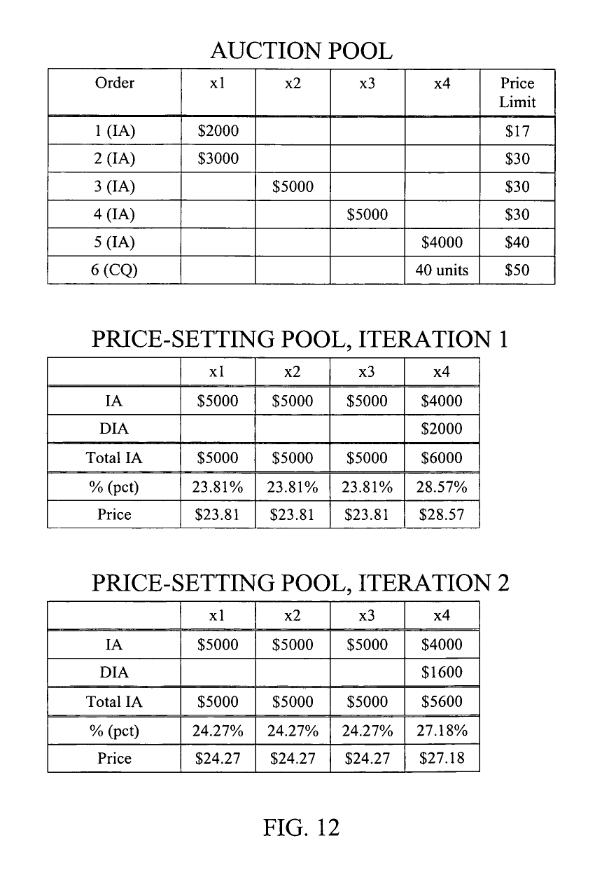

Now consider the treatment of CQ orders. In the examples so far, the auction pool contained only IA orders and mutualized risk price setting is well suited for IA orders. As a result, one approach for handling CQ orders is to convert them to equivalent or “dummy” IA orders (DIA orders), typically on the basis of Eqn. 4. This can be done in many ways. FIG. 12 shows some examples.

In FIG. 12, the Auction Pool has five IA orders with price limits, and order 6 is a CQ order for 40×4 with a price limit of $50. In one approach, the CQ order is converted to the most aggressive equivalent IA order and just treated as that for price setting purposes. In this example, the maximum investment amount for order 6 is 40 units×$50=$2000. Thus, the DIA for order 6 is $2000x4, price limit of $50. Price is then set using this DIA without changing it, as shown in iteration 1 of the price setting pool of FIG. 12. Note that the total IA for x4 is $6000: $4000 from order 5 and the $2000 DIA from order 6. The resulting ASPs are shown in iteration 1. Note that the DIA is used strictly for price setting purposes. Order 6 is not actually filled on the basis of the DIA. Rather, the DIA is used to set ASPs, and then orders are filled in the quantity auction based on the ASPs.

In FIG. 12, note the aggressiveness of this approach. The $2000 DIA amount assumed that the price of x4 would be the maximum allowed: $50. In fact, the price for x4 turned out to be significantly less: $28.57. The corresponding investment amount would be 40 units×$28.57=$1142.80. Using this investment amount instead of the more aggressive $2000 would affect the total IAs in the price setting pool, which would then affect the prices.

This effect can be handled in a number of ways. For example, it could just be ignored. If the volume of CQ orders is relatively small, the overall effect will also be small. Plus, it is an effect in price setting not in actual trading. The buyer does not actually lose money in the sense that he does not pay $50 for a unit of Cx4 that is priced at $28.57. In the subsequent quantity auction, order 6 will be filled and the buyer will actually buy 40 units at the ASP of $28.57.

In another approach, the price setting can be iterated until the discrepancy is resolved. Rather than stopping with iteration 1, the DIA for order 6 can be reduced and then new ICPs calculated based on the adjusted price setting pool. This may be repeated until the ICPs stabilize, at which point the process is stopped and the ICPs are used as the ASPs. Note that reducing the DIA for order 6 may result in its removal from the price setting pool. In these cases, the DIA preferably should be increased if the current DIA has not yet reached the cap on DIA set by the underlying CQ order.

Iteration 2 of FIG. 12 shows an intermediate approach. In this case, the DIA for order 6 is the most aggressive order for x4. In fact, it is the most aggressive order of all the orders (on the basis of comparing the price limit to the actual ICP). As a result, the DIA is recalculated based on a price selected along the intentions of having the MRPR rise to just below the second-most aggressive order in order to limit reductions in the overall aggressiveness of the order pool. In this case, the second most aggressive order is order 5, with a price limit of $40. So the DIA for order 6 is adjusted using a price of $39.99. The mutualized risk price setting is iterated, yielding the results shown for iteration 2. These prices would be the ASPs, except that the price limit for order 1 is violated. The price setting pool will be adjusted and iterated again, using the techniques described previously for price limits.

Moving on to combination orders, the importance of combination orders may not be apparent given the discrete contract examples that are shown. However, recall that these examples are used because they are simple but sufficient to illustrate various principles. In many applications, the native contracts in the market may have a wide variety. Hence, a set of basic units may be chosen to represent the “least common denominator” between the native contracts and, therefore, many native contracts may be decomposed into two or more basic units. Orders for these contracts likely will be treated as combination orders.

The treatment of combination orders can be separated into two areas for mutualized risk price setting purposes. One is the allocation of the combination amounts to the individual basic units. For example, an IA $1000(x1 and x2) could be treated as $500 in x1 and $500 in x2 for mutualized risk price setting purposes, or $700 in x1 and $300 in x2, or etc. The second area is the effect of combination on the price setting exercise. For example, should the basic units making the combination be treated as independent basic units or as a combination.

The answer to the first question depends at least in part on the allocation policy for the order. The allocation policy determines how investment amounts should be allocated between the basic units. One type of allocation policy is a static allocation policy. Here, the relative ratios between basic units are predefined and fixed. For example, in the above example, a static allocation policy of 1:1 between x1 and x2 means that the $1000 investment amount should be allocated as $500 in x1 and $500 in x2. It will be treated as such for the price setting pool.

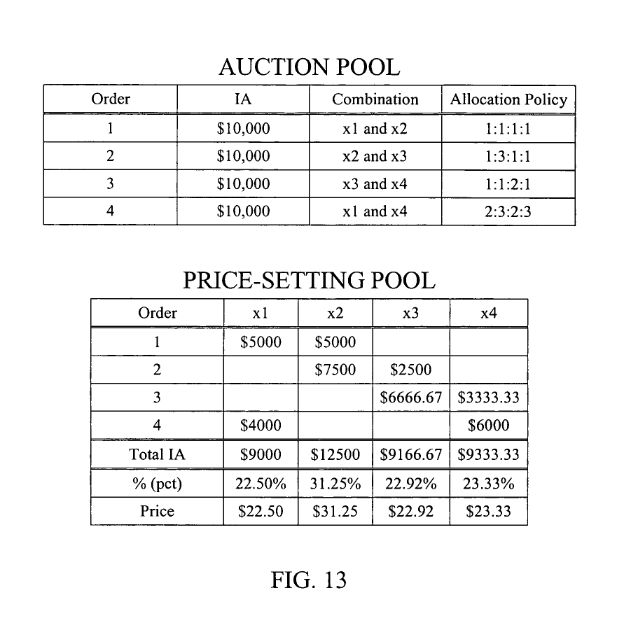

FIG. 13 shows an example. Here, the auction pool includes four combination orders, each with a static allocation policy. In the price setting pool, the investment amounts are allocated to basic units according to this policy. For example, order 2 has an investment amount of $10,000(x2 and x3) allocated 1:3:1:1. Three times as much goes to x2 as to x3, so $7500 is allocated to x2 and $2500 to x3. Standard mutualized risk price setting is applied to this price setting pool to arrive at the pricing.

Another type of allocation is market driven allocation. Basically, the allocation policy is based on some order-driven policy. Market driven allocations can be static. In an example of a market driven allocation that is not static, the allocations are based on the ratios of the pricing. For example, if the prices of x1 and x2 are $25 and $35, respectively, then a 1:1 exact, market driven allocation means the investment amount will be divided in the ratio of 25:35 between x1 and x2. Heuristically, if Cx1 and Cx2 have the same notional, this will translate into a 1:1 ratio in the quantities. This, in turn, means that the payoff will be the same if either x1 or x2 occurs. A 1:2 exact, market driven allocation means that the investment amount will be divided in the ratio of 25:70(=2×35) between x1 and x2.

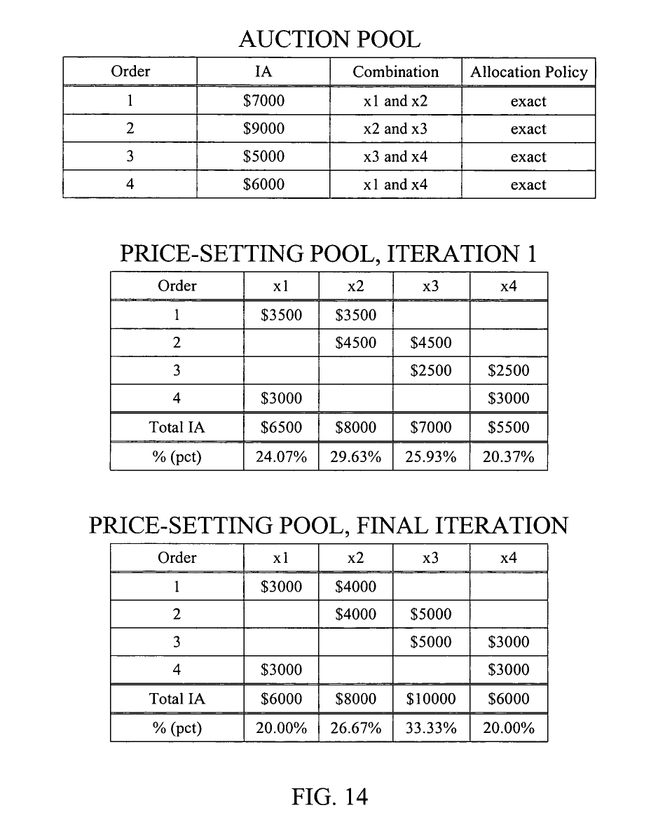

FIG. 14 shows an example. The auction pool includes four combination orders. The actual allocation is determined iteratively in this example. In the first iteration of the price setting pool, the amounts are allocated according to some initial guess: 1:1:1:1 in this case. Mutualized risk price setting is applied to arrive at the ICPs of $24.07 for x1, $29.63 for x2, etc. in the first iteration. These ICPs are used as the allocation policy for the next iteration. That is, the allocation policy is 2407:2963:2593:2037. The process is iterated until the ICPs converge, as shown in the table labeled “Price setting Pool, Final Iteration.”

As a final example of allocation, consider the call spread shown in FIG. 5A. Note that each digital range basic unit can be decomposed into a corresponding converging and diverging basic unit. Accordingly, the call spread can be decomposed into the following basic units: 1 diverging 100/110, 1 converging 110/120, 2 diverging 110/120, 2 converging 120/130, 3 diverging 120/130, 3 converging 130/next strike and 3 diverging 130/next strike. Recall that the sum of the prices of the diverging basic unit and the corresponding converging basic unit equals the price of the digital range. The ratio of the prices of the converging and diverging basic units can be determined by an allocation policy, including non-static allocation policies (e.g., based on the ICP calculated in the previous iteration, or 1:1 for the first iteration).

Assume for purposes of illustration that the prices of all basic units involved in the call spread are equal (e.g., as might be the case to start the first iteration), then this allocation yields a relative weighting of 0:1:1:2:2:3:3:3 for the amount buying converging 100/110: diverging 100/110: converging 110/120: diverging 110/120: converging 120/130: diverging 120/130: converging 130/next strike: diverging 130/next strike. Therefore, if the total investment amount for this order is IA $1000, the amount allocated to diverging 100/110 is $1000x1/(1+1+2+2+3+3+3)=$66.67, to converging 110/120 is $1000x1/(1+1+2+2+3+3+3)=$66.67, to diverging 110/120 is $1000x2/(1+1+2+2+3+3+3)=$133.33, and so on.

With these IAs that are buying different (sub) basic units, we can calculate the next ICP for each (sub) basic unit. Regardless of what allocation policy is used, application of the allocation policy allows a combination order to be broken into a number of basic units. For example, an IA $1000(x1 and x2) might be broken into $500 in x1 and $500 in x2 according to its allocation policy. These basic units can then be used in the mutualized risk price setting calculation, assuming that they are part of the price setting pool.

However, the second issue raised above concerns how to handle combination orders with respect to the price setting pool. In one approach, the basic units are treated together as an indivisible combination and they are either all in the price setting pool or all out of the price setting pool (or in the price setting pool on a pro rata basis, if the combination order is only partially eliminated from the price setting pool). At the opposite end of the spectrum, each basic unit is treated separately and is independently part of the price setting pool, or not. Intermediate approaches can also be taken.

For example, in step 924 of FIG. 9A, basic units in the price setting pool are tested to see if any of their price limits have been violated. In the first approach, the price limit for the combination would be tested for violation, with the result applying to both basic units. In the latter approach, each basic unit would be tested separately (note that the price limit would also have to be allocated between the basic units, which can be done using the same approaches described above). Thus, the price limit for the x1 basic unit might be violated whereas the price limit for the x2 basic unit might not be. It is possible that one basic unit would be part of the price setting pool and the other would not be. This might be problematic if orders were being filled. Recall that combination orders cannot be filled in this manner. However, in this case, no trades are actually being made; the price setting pool is used to set price.

As mentioned previously, several different contract variations have been considered in turn, including price limits, short orders, addition of CQ orders, and combination orders. The principles shown in these figures can be combined to handle auctions with different combinations of these variations.

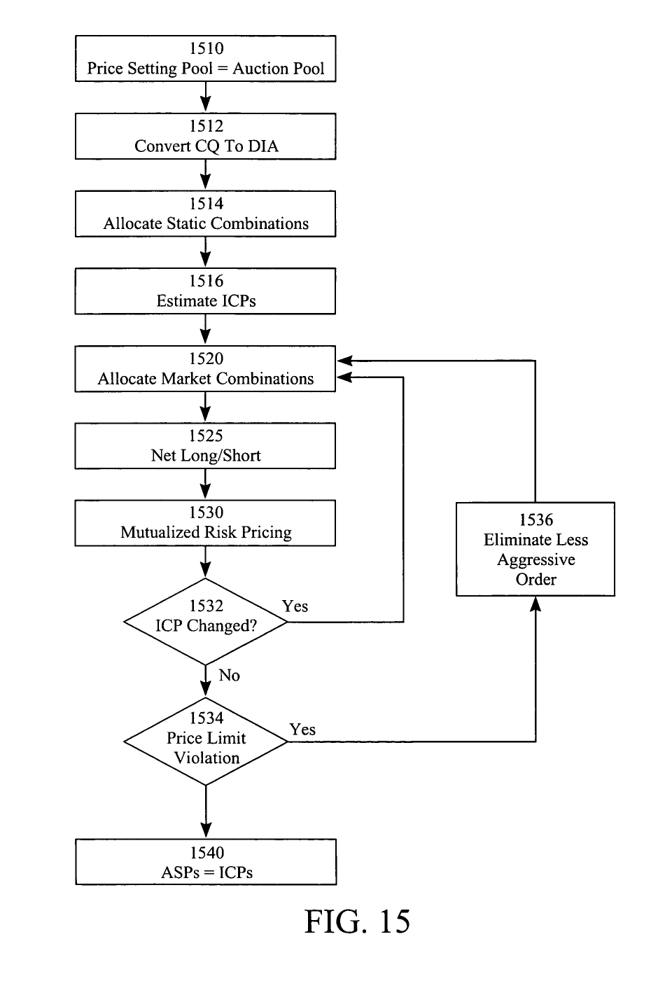

FIG. 15 is an example used to illustrate this point. In this example, it is assumed that the auction pool is primarily IA but can also include CQ orders. Price limits and combination orders are permitted. The combination orders can use either static or non-static allocation. Short orders are also permitted but it is expected that all basic units will have a net long position. As a result, the auction organizer sets the policy that pricing will be based on net long positions. FIG. 15 shows one method for mutualized risk price setting that combines the various principles discussed above.

The price setting pool initially is set 1510 to include all orders in the auction pool. CQ orders are converted 1512 to DIA orders. In this example, the auction organizer sets the policy that tthe conversion will assume the most aggressive DIA order and the DIA orders are not iterated or changed for the rest of the process. Static combinations are allocated 1514 into basic units according to their static allocation policy. Note that steps 1512 and 1514 are performed once and are not affected by subsequent changes in the price setting pool.

ICPs are estimated 1516 using mutualized risk price setting, based on all non-combination orders, DIA orders and static combination orders, with longs and shorts netted. These ICPs are used to allocate 1520 the market-driven combination orders. At this point, orders in the price setting pool have been allocated to basic units. So long and short positions are netted 1525. The resulting net long position is used to set 1530 the ICPs, based on mutualized risk price setting. If the ICPs change 1532, then the allocation of market-driven combination orders is iterated until the ICPs stabilize.

After the ICPs stabilize, the price setting pool is checked 1534 for violations of price limits. If there is a violation, the least aggressive order for a basic unit is eliminated 1536 from the price setting pool (more likely, a portion of the order is eliminated (diagram needs according amendment)) and the loop is repeated. Note that the loop from 1536 is shown as reentering 1520. This is done in order to more clearly show two loops. In reality, step 1520 can be skipped when returning from 1536 because the ICPs have not changed from the last iteration. Once the ICPs stabilize 1532 and there are no price violations 1534, the process completes. The most recent ICPs are used 1540 as the ASPs. FIG. 15 is merely an example. Other combinations of contracts and approaches to handling contract variations can also be combined to form different methods.

Let us now leave mutualized risk pricing and turn to another pricing mechanism that shall be referred to as Dutch auction pricing for convenience, since it is based on Dutch auction principles. The same approach will be taken here as was taken with mutualized risk pricing. FIG. 16A illustrates the basic scenario for Dutch auction price setting, which is a specific embodiment of step 722 of FIG. 7. The majority of the remaining Dutch auction examples concern steps 720, 726—how to select the price setting pool for the Dutch auction. In particular, each of the following will be addressed in turn: short orders, addition of IA orders, and combination orders. The principles shown in these figures can be combined to handle auctions with different combinations of these variations.

FIGS. 16A-16B illustrate the basic Dutch auction price setting mechanism. Assume for the moment that all orders are CQ, at least some with price limits, no shorts, and no combinations. Then, the ASPs aredetermined as follows. Orders for each basic unit are ranked in order of aggressiveness. In the example of FIG. 16B, each column under a basic unit ranks the basic units in descending order of price. The highest offer price for x1 is $30, second highest is $28, etc. Orders without price limits are placed at the top of the list since they can be considered to have an infinite price limit. In FIG. 16B, each row, which shall be termed a slice, represents a quantity of one. Thus, an order for five units would occupy five rows. This is done for illustrative purposes. Actual implementations may or may not use this specific tructure. Slice 1 contains the highest offers for each of x1, x2, etc.

Slice 1 represents a complete set with an offer price of $113, as shown in the column “Offer price.” Since the value of a complete set is known to be $100 (assuming $100 notional), slice 1 is accepted for inclusion in the price setting pool. This process is repeated for slice 2, and so on, until the boundary between accepted and rejected slices is determined. In FIG. 16B, the boundary is denoted by the dark line between slice 5 and the first rejected slice. The accepted slices form the price setting pool.

The last accepted slice (or slices) is used to calculate the ASPs. In this example, the offer price for the last slice is $101. The settlement value is only $100, so each of the individual offer prices is reduced, in this case proportionally by multiplying each offer price by 100/101, to arrive at the ASPs. Naturally, there are many ways to determine the ASPS. For example, the prices from the last two slices could be averaged. Alternately, the prices from the last accepted slice and the first rejected slice could be averaged, in which case the first rejected slice would also be part of the price setting pool.

This is Dutch auction price setting, as shown in FIG. 16A. The price setting pool is empty 1420 to begin with. Orders are ranked 1422 by aggressiveness and complete sets are formed 1423 beginning with the most aggressive orders. Complete sets, which have an offer price greater than or equal to 1424 the settlement value are accepted 1426 into the price setting pool. At some point, the offer price of the complete sets typically will fall below the settlement value (if not, the last complete set can be used as the last slice). The last slice and slices above it form the price setting pool, and ASPs are determined 1430 based on the last slice(s).

Now consider the situation with shorts. FIGS. 17A and 17B show an example of one way to handle sell orders. The sell orders are converted to equivalent buy orders using Eqn. 3A. Thus, an order to sell x1 at $22 is converted to an order to buy (not x1) at $78, assuming a $100 notional. The “Draw Pool” in FIG. 17A shows the rankings for all of the contracts in the auction pool. In this case, there are five quantities ordered for each of the eight possibilities of buy/sell basic units.

This situation is slightly different from FIG. 16B because complete sets can now be formed in more than one way. In FIG. 16B, there was only one possible complete set: {x1, x2, x3, x4}. In FIG. 17A, there are six possible complete sets:

buy all: {x1, x2, x3, x4}

sell all: {not x1, not x2, not x3, not x4}

trade x1: {x1, not x1}

trade x2: {x2, not x2}

trade x3: {x3, not x3}

trade x4: {x4, not x4}

Based on the current values in the draw pool, the best offers for each of these complete sets is tabulated under the heading “Best offers for slice 1.” Note that the offer for “sell all” is the sum of the offers reduced by an integer number of settlement values (specifically, the number of basic units−2). This is because the conversion Eqn. 3A introduces additional complete sets, the value of which must be removed to provide fair comparison.

Of the six possibilities, “buy all” is the best offer and the corresponding basic units are removed from the draw pool and placed into slice 1 of the price setting pool. FIG. 17B shows the price setting pool and the draw pool after this first iteration. The process is repeated for the remaining offers in the draw pool until the best offer (possible) falls below the settlement value. The resulting price setting pool is shown in FIG. 17C.

Slice 8 is the last slice. However, the complete set for slice 8 is trade x1. Hence, it only contains values for x1 and not x1. From this information, only a price for x1 can be determined. Prices for x2, x3 and x4 cannot be determined from this slice. In fact, the price setting pool must be backed up to slice 4 before pricing information for all four basic units is obtained.

The information in slices 4-8 can be used in many different ways to determine the ASP. For example, the ASP for x1 could be based on all of the prices for x1 in all of the slices 4-8. Alternately, it could be based on just the last slice that had pricing for x1 (slice 8 in this case). If multiple prices are used to establish the ASP, they can be averaged in many different ways. In fact, information from earlier slices (slices 3 and up) could also be used to determine the ASP, although this starts to get away from the underlying Dutch auction concept.

In an alternate implementation, the sells are not converted to equivalent buys. Rather, they are left as sells. For example, an offer to sell x1 at $22 is left as that, rather than converting it to an offer to buy (not x1) at $78. Note that lower offers to sell are more price aggressive, whereas higher offers to buy are more price aggressive. The price aggressiveness of the six complete sets can be calculated as the “profit” of that transaction:

buy all: Profit=bid price of x1+bid price of x2+bid price of x3+bid price of x4−notional

sell all: Profit=notional−offer price of x1−offer price of x2−offer price of x3−offer price of x4

trade x1: Profit=bid price of x1−offer price of x1

trade x2: Profit=bid price of x2−offer price of x2

trade x3: Profit=bid price of x3−offer price of x3

trade x4: Profit=bid price of x4−offer price of x4

The most aggressive complete set is the one with the highest “profit”. The boundary defining the last slice occurs when the profit drops below zero.

Now consider the treatment of IA orders. In all of the Dutch auction examples so far, the auction pool contained only CQ orders and Dutch auction price setting is well suited for CQ orders. As a result, IA orders can generally be handled by converting them to equivalent or “dummy” CQ orders (DCQ orders) using techniques that are entirely analogous to those discussed above with respect to converting CQ orders to dummy IA orders.

For example, consider an IA $500x1, MRPR 4. The MRPR 4 means that the price must be $25 or less (assuming $100 notional). If the price is $25 or less, then the quantity must be $500/25=20 or more. Thus, the most aggressive stance is to convert the IA order to a DCQ order of quantity 20 with a price limit of $25. As with the CQ to DIA case, less aggressive approaches can be taken by increasing the quantity of the DCQ order using any number of methods, but preferably keeping in line with the pricing of the Dutch auction.

Combination orders can also be handled analogously to the mutualized risk case. Again, two important issues for handling combination orders are the allocation of the combination amounts to the individual basic units and the effect of combinations on the Dutch auction price setting exercise.

With respect to allocation, the issue typically is the allocation of a price limit. A CQ 10(x1 and x2), price $60 is an order for 10 units of x1 and 10 units of x2, with a maximum of $60 for the combined price of x1 and x2. A static allocation of 1:2 means that the $60 price limit would be split as a maximum price of $20 for x1 and $40 for x2.

An exact, market driven allocation means that any combination of pricing for x1 and x2 is acceptable, as long as it does not exceed $60. For purposes of price setting, the price limit preferably is allocated according to the prices of x1 and x2. For example, if the prices of x1 and x2 are $20 and $30, then the price limit can be allocated as $24 for x1 and $36 for x2. The exact allocation can be determined iteratively, as described with respect to the example allocation for IA combination orders.

In addition to allocation, there are also different ways to handle combinations within the Dutch auction price setting mechanism. In one approach, each basic unit is treated independently. It is free to be ranked independently of the other basic units that make its combination. In fact, one basic unit from a combination could be in the price setting pool (i.e., above the last slice) while another from the same combination would not be.

Other approaches are also possible. For example, one special case of combination orders has already been discussed at length. That is the case of sell orders. In the above example, an order to sell x1 with price limit $22 is converted to an order to buy {x2, x3, x4} with price limit $78. This is a combination order. If the independent basic unit approach were taken, the $78 price limit would be allocated among x2, x3 and x4, and then each of these basic units would be treated as if they were independent orders. That approach was not taken above (although it could be).

Instead, all combination orders were kept intact. For each slice, all possible complete sets were evaluated for aggressiveness and the most aggressive selected for the next slice. This was feasible because, given the existing combinations, there was a manageable number of different complete sets (six in the example of FIG. 17). This may not always be the case. An alternate approach is to rank all the units in the draw pool (including both combinations and noncombinations) according to aggressiveness and then try to form complete sets beginning with the most aggressive. Other approaches will be apparent, some of which are discussed below in the context of the quantity auction. Regardless of the exact approach, once the price setting pool is formed (or after completion of iterations), the ASPs for the contracts are determined.

Price setting mechanisms other than mutualized risk or Dutch auction can also be used for the price auction. For example, the ASPs can be set entirely by external factors without regard for what orders are in the auction pool. For example, the ASPs might be set by widely recognized exchanges, market dealers, and/or commericial entities such as major bookmakers and trade associations. Alternately, some combinations of external factors and the auction pool can be used to set the ASPs.

One advantage of separating the price auction from the quantity auction is that it results in added flexibility. For example, the price auction can be based on a small subset or a sampling of the orders in the auction pool. This can significantly speed up the price determination since the entire auction pool need not be processed. If the sampling is random (or otherwise does not skew the results), then the final ASPs should still be representative of the entire auction pool. Other simplications can also speed up the price auction. For example, price and/or quantities can be rounded for price setting purposes. Or price setting can be based primarily, or solely, on large orders or orders from specific sources. Earlier orders may be given preference in order to encourage faster development of the auction. For iterative processes, a looser convergence criterion can be used. The iteration can be stopped when the change falls below a rather large percentage, rather than waiting for complete convergence. Other variations will be apparent. These possibilities result because the price auction is separated from the quantity auction and, therefore, the price auction needs not be as exact as it would be if the price auction determined both the ASPs and which orders were filled.

In some cases, the price auction will also naturally fill orders so that a separate quantity auction is not required. For example, if the Dutch auction-based price auction is well behaved (e.g., no broken combination orders) and is conducted in an exact and exhaustive manner (i.e., no shortcuts and all orders are considered), theoretically, it could result in a price setting pool which also defines which orders should be filled. A similar situation exists with the mutualized risk approach.

For example, refer again to FIG. 8. In this example, there are $1000 worth of IA x1 orders, $2000 worth of IA x2 orders, etc. The auction is settled according to the calculation shown in FIG. 8 and the resulting ASPs are $10 for x1, $20 for x2, etc. All the orders are qualified orders (i.e., all order are within price limits). Based on these ASPs, all IA orders reflected in FIG. 8 can be filled. There is no need for a separate quantity auction. The $1000 worth of IA x1 orders will be converted to 100 units of Cx1 (recall the notional was $100), the IA x2 orders to 100 units of Cx2, etc. One advantage of this conversion from IA orders to specific quantities of Cxn contracts is that it facilitates subsequent trading. For example, assume that there are a number of auctions for the events x1-x4 before the events themselves actually occur. The prices set in each auction may differ, for example if the auctions are spaced in time or attract different participants. Assume that FIG. 8 represents the results of one such auction, and FIG. 11 represents the results of another auction. It is difficult to establish trading between, an IA $100x1 order from the FIG. 8 auction and an IA $100x1 order from the FIG. 11 auction. However, after conversion, the FIG. 8 IA order is converted to $100/$10=10 units of Cx1 and the FIG. 11 IA order is converted to $100/$40=2.5 units of the same Cx1. Conversion to the same underlying contract Cx1 establishes a common currency for trading. The relative values of the two $100IA orders are taken into account by the different MRPRs (or, equivalently, the different prices) of the two auctions.

Returning to FIG. 7, the mutualized risk and Dutch auction mechanisms can be used as price auctions 710 to set ASPs for the contracts in the auction pool. More specifically, in many cases, these mechanisms set ASPs for the basic units and the ASPs for the contracts are determined from the basic unit ASPs. In FIG. 7, oonce the ASPs are set, the quantity auction 750 determines which orders in the auction pool are to be filled.

FIGS. 18-20 describe different variations of quantity auctions. All of these examples follow the specific embodiment shown in the interior of 750, although other types of quantity auctions will be apparent. In particular, the quantity auction begins by determining 760 a qualified pool, based on the ASPs set by the price auction. The qualified pool is the set of orders from the auction pool, which are consistent with the ASPs. For example, if one order in the auction pool was CQ 10x1 with a price limit of $27 and the ASP for x1 was set at $30, this order would not be part of the qualified pool. The qualified pool is then used to determine 762 the in pool. The in pool contains the set of orders (or partial orders) that are actually filled, using the ASPs set by the price auction. The out pool is the set of unfilled orders (and partial orders).

Ideally, the in pool and the qualified pool would be exactly the same, meaning that all qualified orders would be filled in their entirety and no unqualified orders would be filled. If this is known to be the case a priori and the qualified pool is determined as part of the price auction, a separate quantity auction is not required. The well-behaved cases described above are examples of this.

In reality, the qualified pool and the in pool may not be the same, particularly for complex auctions. FIGS. 18-20 are examples of different ways to determine the in pool from the qualified pool. In FIG. 18, the qualified orders are ranked 1810, for example by aggressiveness.

An example measure of aggressiveness is the percentage difference between the order's offer price limit and the actual order price calculated with ASP. Other measures of aggressiveness, or measures besides aggressiveness, can be also used, as has been discussed above. The orders are considered in rank order to form 1820 complete sets. The maximum number of complete sets is identified and these orders are filled 1830.

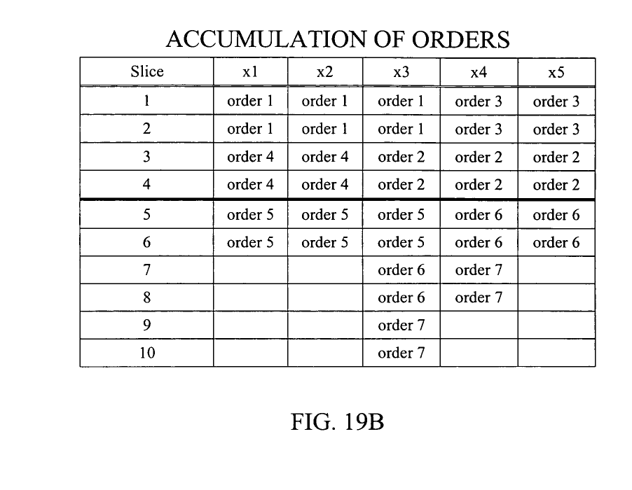

FIGS. 19A-19B are two examples of how complete sets can be formed 1820 based on a ranking. In these examples, the qualified pool has seven orders of quantity two each. The table “Ranking of Qualified Pool” in FIG. 19A lists these orders by decreasing aggressiveness. Order 1 is the most aggressive and order 7 is the least aggressive. Note that these are all combination orders. All basic units for the combination order must be filled in the specified proportion in the order. For example, the quantity auction cannot fill just the x1 portion of order 1 and leave the x2 and x3 portions unfilled.

In FIG. 19A, the orders are accumulated by basic unit, starting with order 1 and working up to order 7. In the diagram, each box represents one unit of the respective basic unit. Each row represents a complete set. Thus, 2x1, 2x2 and 2x3 are accumulated for order 1, as denoted by the top two boxes for x1, x2 and x3, which are labeled “order 1.” Order 2 is then accumulated. Note that the 2x3 for order 2 are the third and fourth boxes for x3 since order 1 has occupied the first two spaces. This process is repeated for order 3, order 4, . . . to order 7. The result is depicted graphically in FIG. 19A. The largest number of complete sets that can be filled without breaking combinations is four, as indicated by the heavy line. Those four complete sets (or slices) are formed by orders 1, 2, 3 and 4, so those orders are filled. The remaining orders can be handled in many different ways, some of which will be described in more detail below. Basic units that are accumulated as part of incomplete sets (i.e., the x3 and x4 basic units for slices 7-10 in this example) shall be referred to as residuals.

In an alternate way to form complete sets, the possible combinations of orders are also ranked and this ranking is used to form the complete sets. For example, one possible ranking of combinations of four orders is the following: 1, 1-2, 1-2-3, 1-2-3-4, 1-3, 1-3-4, 1-4, 2, 2-3, 2-3-4, 2-4, 3, 3-4, 4. So order 1 alone would be considered first to see if it made a complete set (although a single order typically would not form a complete set on its own). If so, the order is accumulated. The process then moves to the next possible combination. If order 1 was accumulated, then the next possible complete set would be 2 alone, since all the 1-combinations would not be possible. If order 1 was not accumulated, then the next possible combination would be 1-2. If it is a complete set, then orders 1 and 2 are accumulated. The process repeats. One advantage of the specific ranking given above is that no complete set without order 1 will be accumulated until all possible combinations with order 1 have first been considered. More generally, no complete set without a specific order will be accumulated until all possible combinations with that specific order have first been considered. One disadvantage is that if there are a large number of different types of orders, the number of possible combinations can also become large.

One way to reduce this complexity, if necessary, is to limit the number of orders in each combination. For example, the order given above reduces to the following if the combinations are limited to two orders: 1, 1-2, 1-3, 1-4, 2, 2-3, 2-4, 3, 3-4, 4. FIG. 19B shows the result of applying this approach to the qualified pool shown in FIG. 19A. The complete set 1-3 is formed first, followed by 2-4. No further complete sets can be formed and the residual contracts are accumulated in rank order: 5, 6, 7. Note that the diagram in FIG. 19B is not the same as the one in FIG. 19A. In this particular example, the same four orders are filled, but this is not always the case.

Another way to reduce the number of possible combinations is to take advantage of information about the possible orders. For example, assume that the auction is limited to the following eight contracts: x1, x2, x3, x4, not x1, not x², not x3 and not x4. Also assume that order 1 is for x4. Then, a complete set can only be formed in two possible ways: {x4, x1, x2, x3} and {x4, not x4}. Thus, the list of 1-combinations can be evaluated by finding the highest ranking orders for x1, x2 and x3; finding the highest ranking order for (not x4), and determining which combination has the higher ranking. For example, assume that orders 87, 7 and 12 are the highest-ranking orders for x1, x2 and x3. This corresponds to the combination 1-7-12-87. Further assume that order 9 is the highest-ranking order for (not x4). This would be combination 1-9. Combination 1-7-12-87 ranks ahead of 1-9 and would be used to accumulate order 1 (as well as 7, 12 and 87, or portions of the orders depending on the quantities for each order). If there are residual quantities remaining in order 1, then the process can be repeated.

As another example, consider the case where the basic units are limited to those shown in FIG. 5B: a digital call, a digital put, digital ranges between the call and put, and converging and diverging corresponding to the digital ranges. Now assume that Order 1 is a combination order that has a converging basic unit. With the set of basic units shown, a complete set can be formed only if one of the other orders contains the corresponding diverging basic unit. This observation can be used to accelerate the search for complete sets.

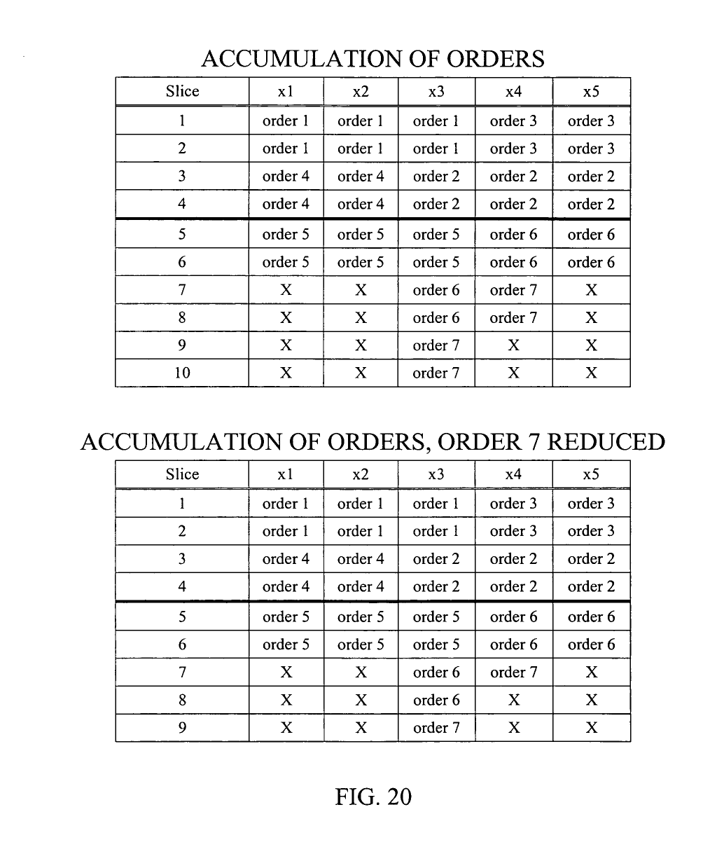

Referring now to FIG. 20, the top table duplicates the table shown in FIG. 19A. Orders 1-4 are filled. They are complete combinations (or pro rata portions of combinations) that form complete sets. The remaining orders can be handled in a number of different ways. For example, they can simply remain unfilled. Alternately, the auction organizer (or someone else) can buy/sell contracts to make complete sets, in order to fill these orders. In the top table of FIG. 20, 4x1, 4x2, 2x4 and 4x5 would have to be bought (as denoted by the X's) in order to complete 10 slices and fill all orders.

If this is too much, the organizer can reduce the number of unfilled orders, preferably in order of rank, until the amount to be bought is acceptable. In the bottom table of FIG. 20, order 7 is reduced by one unit. The organizer must now buy 3x1, 3x2, 2x4 and 3x5 to complete 9 slices. This process can be repeated until the X'd area reaches an acceptable level. As an alternative to purchasing the extra units himself, the organizer can fill some or all of the X'd areas using orders from the unqualified pool. For example, if the unqualified pool contains orders for x1, the organizer could move these to the in pool to fill some or all of the X's for x1. However, to do this, the organizer typically will have to fill these orders at a discounted price.

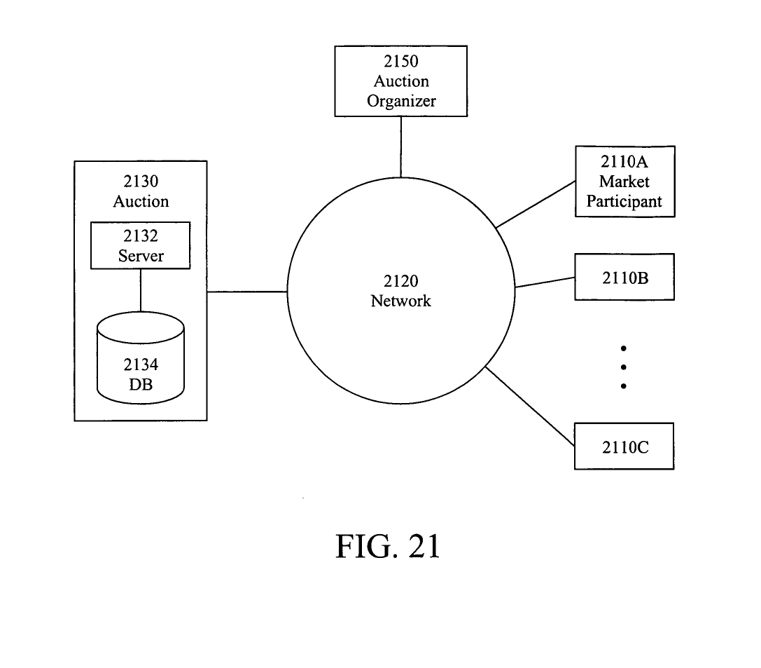

FIG. 21 is a block diagram of a system suitable for use with the present invention. Generally speaking, market participants 2110A-C and the auction organizer 2150 participate in the auction 2130 via a network 2120. The market participants 2110 enter their orders and receive updates about the auction via the network 2120. The auction organizer 2150 can also receive updates about the auction 2130 and can control the auction via the network 2120. In one specific embodiment, the network 2120 is the Internet, and the auction 2130 is hosted on a server 2132, with information stored on a database 2134. The market participants 2110 and the organizer 2150 access the Internet, typically by browsers such as Microsoft's Internet Explorer. The market participants can be individuals, but they can also include other entities, such as automatic trading programs. The server 2132 responds to requests from market participants 2110 and the organizer 2150.

It should be noted that FIG. 21 is simplified for clarity. For example, the roles of market participants 2110 and auction organizer 2150 can be implementation in a distributed fashion and/or divided among many different entities. The auction 2130 itself may also be distributed for redundancy and/or performance reasons. The server 2132 can contain different components, for example different modules to conduct the price auction, the quantity auction and to interface with outside entities (such as updates of stock prices, if relevant). Multiple servers, databases, load balancers, etc. can be used to implement the auction 2130.

As further clarification, the invention may be used with systems other than the Internet. For example, the various entities may communicate with each other over separate communications networks or dedicated communications channels, rather than through the common network 2120 of FIG. 21. Alternately, various parts of the system may be implemented by mobile components and may not be permanently attached to a communications network. For example, the different entities may interact via a wireless connection.

In alternate embodiments, the invention is implemented in computer hardware, firmware, software, and/or combinations thereof. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits) and other forms of hardware.

Although the detailed description contains many specifics, these should not be construed as limiting the scope of the invention but merely as illustrating different examples and aspects of the invention. It should be-appreciated that the scope of the invention includes other embodiments not discussed in detail above. Various other modifications, changes and variations which will be apparent to those skilled in the art may be made in the arrangement, operation and details of the method and apparatus of the present invention disclosed herein without departing from the spirit and scope of the invention as defined in the appended claims. Therefore, the scope of the invention should be determined by the appended claims and their legal equivalents. Furthermore, no element, component or method step is intended to be dedicated to the public regardless of whether the element, component or method step is explicitly recited in the claims.

What is claimed is:

1. A method for settling an auction of contracts comprising:
accessing an auction pool defining orders for contracts collected during an auction; setting an auction settlement price (ASP) for each contract in the auction pool; and
after the ASPs have been set, filling orders in the auction pool based on the ASPs.
